(19) United States
(12) Patent Application Publication
(10) Pub. No.: US 2024/0414366 A1
(43) Pub. Date: Dec. 12, 2024

(54) LOCAL ILLUMINATION COMPENSATION WITH CODED PARAMETERS

(71) Applicant: MediaTek Singapore Pte. Ltd., Singapore (SG)

(72) Inventors: Olena CHUBACH, San Jose, CA (US); Chih-Wei HSU, Hsinchu City (TW); Tzu-Der CHUANG, Hsinchu City (TW); Ching-Yeh CHEN, Hsinchu City (TW); Yu-Wen HUANG, Hsinchu City (TW); Chun-Chia CHEN, Hsinchu City (TW)

(21) Appl. No.: 18/712,014

(22) PCT Filed: Nov. 25, 2022
(86) PCT No.: PCT/CN2022/134450

§ 371 Date: May 21, 2024

Related U.S. Application Data
(60) Provisional application No. 63/283,315, filed on Nov. 26, 2021.

(51) Int. Cl. H04N 19/52; H04N 19/132; H04N 19/139; H04N 19/172; H04N 19/176; H04N 19/182; H04N 19/184; H04N 19/186

(52) U.S. Cl. CPC H04N 19/52; H04N 19/132; H04N 19/139; H04N 19/172; H04N 19/176; H04N 19/182; H04N 19/184; H04N 19/186

(57) ABSTRACT

A video coding system that uses local illumination compensation to code pixel blocks is provided. A video encoder receives samples for an original block of pixels to be encoded as a current block of a current picture of a video. The video encoder applies a linear model to a reference block to generate a prediction block for the current block. The linear model includes a scale parameter and an offset parameter. The video encoder may use the samples of the original block and samples from a reconstructed reference frame to derive the scale parameter and the offset parameter. The video encoder signals the scale parameter and the offset parameter in a bitstream. The video encoder encodes the current block by using the prediction block to reconstruct the current block.

### CROSS REFERENCE TO RELATED PATENT APPLICATION

The present disclosure is part of a non-provisional application that claims the priority benefit of U.S. Provisional Patent Application No. 63/283,315, filed on 26 Nov. 2021. Contents of above-listed applications are herein incorporated by reference.

### TECHNICAL FIELD

The present disclosure relates generally to video coding. In particular, the present disclosure relates to methods of Local Illumination Compensation (LIC).

### BACKGROUND

Unless otherwise indicated herein, approaches described in this section are not prior art to the claims listed below and are not admitted as prior art by inclusion in this section.

High-Efficiency Video Coding (HEVC) is an international video coding standard developed by the Joint Collaborative Team on Video Coding (JCT-VC). HEVC is based on the hybrid block-based motion-compensated DCT-like transform coding architecture. The basic unit for compression, termed coding unit (CU), is a 2N×2N square block of pixels, and each CU can be recursively split into four smaller CUs until the predefined minimum size is reached. Each CU contains one or multiple prediction units (PUs).

Versatile Video Coding (VVC) is a codec designed to meet upcoming needs in videoconferencing, over-the-top streaming, mobile telephony, etc. VVC address video needs from low resolution and low bitrates to high resolution and high bitrates, high dynamic range (HDR), 360 omnidirectional, etc.

Inter prediction creates a prediction model or prediction block from one or more previously encoded video frames as reference frames. One method of prediction is motion compensated prediction, which forms the prediction block or prediction model by shifting samples in the reference frame(s). Motion compensated prediction uses motion vector that describes transformation from one 2D image(s) to another, usually from temporally neighboring frames in a video sequence.

### SUMMARY

The following summary is illustrative only and is not intended to be limiting in any way. That is, the following summary is provided to introduce concepts, highlights, benefits and advantages of the novel and non-obvious techniques described herein. Select and not all implementations are further described below in the detailed description. Thus, the following summary is not intended to identify essential features of the claimed subject matter, nor is it intended for use in determining the scope of the claimed subject matter.

Some embodiments of the disclosure provide a video coding system that uses local illumination compensation to code pixel blocks. In some embodiments, a video coder receives data to be encoded or decoded as a current block of a current picture of a video. The video coder signals or receives a scale parameter and an offset parameter. The video coder applies a linear model to a reference block to generate a prediction block for the current block, wherein the linear model comprises the scale parameter and the offset parameter. The video coder reconstructs the current block by using the prediction block.

In some embodiments, a video encoder receives samples for an original block of pixels to be encoded as a current block of a current picture of a video, and the video encoder may use the samples of the original block and samples from a reconstructed reference frame to derive the scale parameter and the offset parameter. In some embodiments, the samples of the original block that are used to derive the scale and offset parameters are those to be encoded as the current block. In some embodiments, the current block is to be encoded as multiple sub-blocks, with each sub-block having its own motion vector referencing pixels in reference frames. The encoder uses the samples of the original block and the samples referenced by the motion vectors of the multiple sub-blocks to derive the scale parameter and the offset parameter of the linear model.

In some embodiments, the values of the scale and offset parameters are selected from pre-defined sets of permissible values. Each set of permissible values has a finite range and is created by sub-sampling a consecutive sequence of numbers uniformly or non-uniformly. In some embodiments, an index is used to select a value from a predefined set of permissible values. The predefined set of permissible values may be ordered with respect to the index according to probabilities of the permissible values in the set.

In some embodiments, the video coder signals or receives an index for selecting an entry from one or more entries of a history-based table. Each entry of the history-based table includes a scale parameter value and an offset parameter value that are used to encode a previous block. The video coder may update the history-based table with a new entry that includes scale and offset parameter values that are used by the linear model to generate the prediction block.

In some embodiments, separate scale and offset parameters are derived and signaled for luma and chroma components. The signaled luma and chroma scale and offset parameters may be coded by one or more scale parameter indices and/or luma LIC parameter indices that select values for the luma and chroma scale and offset parameters, which are in turn used by the encoder to generate prediction blocks for the luma and chroma components. In some embodiments, an offset parameter index that codes a signaled offset parameter specifies the absolute value but not the sign of the signaled offset parameter.

### BRIEF DESCRIPTION OF THE DRAWINGS

The accompanying drawings are included to provide a further understanding of the present disclosure, and are incorporated in and constitute a part of the present disclosure. The drawings illustrate implementations of the present disclosure and, together with the description, serve to explain the principles of the present disclosure. It is appreciable that the drawings are not necessarily in scale as some components may be shown to be out of proportion than the size in actual implementation in order to clearly illustrate the concept of the present disclosure.

FIG. 1 conceptually illustrates the derivation and the use of the linear model for local illumination compensation (LIC) inter-prediction.

FIGS. 2A-B conceptually illustrate identifying reference samples and current samples for deriving the LIC parameters.

FIGS. 3A-B conceptually illustrate using elements from the original frame and a reference frame to derive the LIC parameters.

FIG. 4 illustrates a history-based table that provides previously used LIC scale and offset parameter values for use by the current block.

FIG. 5 illustrates an example video encoder that may implement LIC mode.

FIG. 6 illustrates portions of the video encoder that implement LIC mode.

FIG. 7 conceptually illustrates a process for using LIC mode to encode a block of pixels.

FIG. 8 illustrates an example video decoder that may implement LIC mode.

FIG. 9 illustrates portions of the video decoder that implement LIC mode.

FIG. 10 conceptually illustrates a process for using LIC mode to decode a block of pixels.

FIG. 11 conceptually illustrates an electronic system with which some embodiments of the present disclosure are implemented.

### DETAILED DESCRIPTION

In the following detailed description, numerous specific details are set forth by way of examples in order to provide a thorough understanding of the relevant teachings. Any variations, derivatives and/or extensions based on teachings described herein are within the protective scope of the present disclosure. In some instances, well-known methods, procedures, components, and/or circuitry pertaining to one or more example implementations disclosed herein may be described at a relatively high level without detail, in order to avoid unnecessarily obscuring aspects of teachings of the present disclosure.

Local Illumination Compensation (LIC) is an inter prediction technique that models local illumination variation between the current block and its prediction block as a function of local illumination variation between the current block template and the reference block template. The parameters of the function can be denoted by a scale α and an offset β, which forms a linear equation, that is, α*p[x]+β to compensate illumination changes, where p[x] is a reference sample pointed to by MV at a location x on reference picture. Since a and R can be derived based on current block template and reference block template, no signaling overhead is required for them, except that an LIC flag is signaled for AMVP mode to indicate the use of LIC.

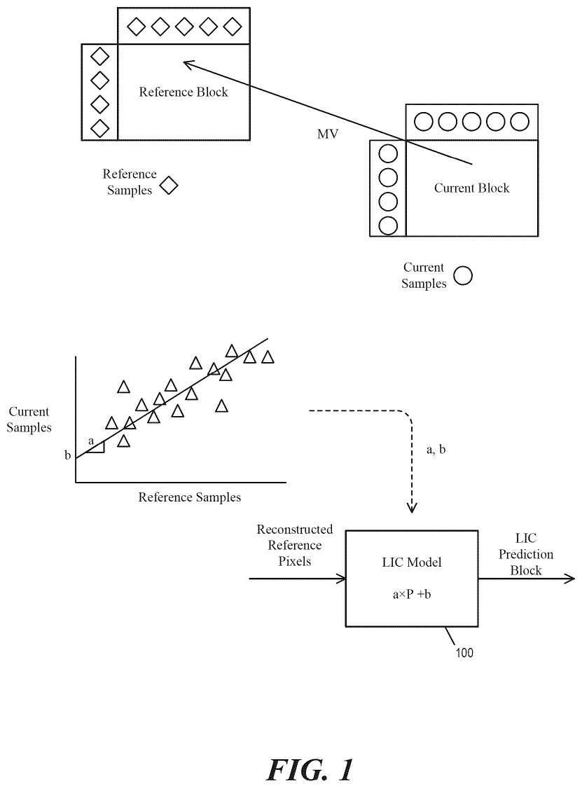

FIG. 1 conceptually illustrates the derivation and the use of the linear model for LIC inter-prediction. As illustrated, corresponding current samples and reference samples are used to derive a linear model 100 (a×P+b). The samples (current samples and reference samples) used to derive the linear model 100 may be drawn from a template (e.g., neighboring pixels) of a current block and a template (e.g., neighboring pixels) of a reference block. When decoding the current block, the derived linear model can be applied to produce a LIC prediction block based on reconstructed reference pixels (e.g., a reference block in a reference frame). The prediction block can then be used to reconstruct the current block.

LIC may be subject to some of the following configuration conditions. When in-loop luma reshaping is used, the inverse reshaping is applied to the neighbor samples of the current CU prior to LIC parameter derivation, since the current CU neighbors are in the reshaped domain, but the reference picture samples are in the original (non-reshaped) domain. LIC enabling flag is signaled once for the CU (so all three components share one flag) but scale and offset parameters are defined for Y/Cb/Cr components separately. LIC is disabled for combined inter/intra prediction (CIIP) and intra block copy (IBC) blocks. LIC is NOT applicable to bi-prediction. LIC is applied to sub-block mode, where LIC parameters are derived based on the samples derived on a sub-block basis. LIC flag is included as a part of motion information in addition to MVs and reference indices. LIC flag is inherited for HMVP. When merge candidate list is constructed, LIC flag is inherited from the neighbor blocks for merge candidates. LIC flag is NOT used for motion vector pruning in merging candidate list generation. NO temporal inheritance of LIC flag. LIC flag is NOT stored in the MV buffer of a reference picture, so LIC flag is always set to false for temporal motion vector prediction block (TMVP). LIC flag is set to FALSE for bi-directional merge candidates, such as pair-wise average candidate, and zero motion candidates. LIC flag is context coded with a single context. When LIC is not applicable, LIC flag is not signaled. Scale α value is in a range between 0 and 128; offset β is in a range between −512 and 511.

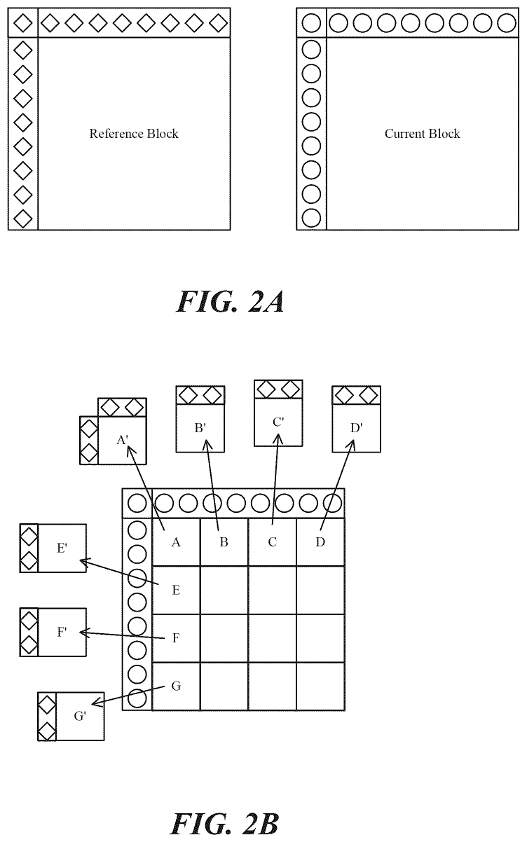

FIGS. 2A-B conceptually illustrate identifying reference samples and current samples for deriving the LIC parameters. FIG. 2A illustrates LIC operations in a non-subblock mode, in which LIC model is derived based on the top and left boundary pixels of the entire blocks. In other words, neighboring pixels of the entire reference block are used as the reference samples and the neighboring pixels of the entire current blocks are used as the current samples. The reference and current samples are used to derive the LIC linear model to be applied to the entire block.

FIG. 2B illustrates LIC operations in a sub-block mode (affine), in which the LIC model is derived based on top and left boundary sub-blocks (labeled A through G) and their referenced sub-blocks (labeled A′ through G′). Specifically, the neighboring pixels of the boundary sub-blocks A-G are used as current samples, while the neighboring pixels of referenced sub-blocks A′-G′ are used as the reference samples. The reference and current samples are used to derive the LIC linear model to be applied to the entire block.

In some embodiments, to derive LIC linear model parameters, linear least square method is utilized. To apply the linear model, 1 multiplication and 1 addition are used per sample, which can be done at the reconstruction stage when prediction is added to the residual. When in-loop luma reshaping is used, the inverse reshaping is applied to the neighbor samples of the current CU prior to LIC parameter derivation, since the current CU neighbors are in the reshaped domain, but the reference picture samples are in the original (non-reshaped) domain.

Table 1A-1C below shows example LIC mode related syntax in coded video:

TABLE 1A
LIC syntax in sequence parameter set

| | Descriptor |
|---|---|
| seq_parameter_set_rbsp( ) { | |
| ... | |
| sps_lic_enabled_flag | u(1) |
| sps_bcw_enabled_flag | u(1) |

TABLE 1B
LIC syntax in slice header

| | Descriptor |
|---|---|
| slice_header( ) { | |
| ... | |
| if( sps_lic_enabled_flag ) | |
| sh_lic_enabled_flag | u(1) |

TABLE 1C
LIC syntax in coding unit:

| | Descriptor |
|---|---|
| coding_unit( x0, y0, cbWidth, cbHeight, cqtDepth, treeType, modeType ) { | |
| ... | |
| if(sh_lic_enabled_flag && inter_pred_idc[ x0 ][ y0 ] ! = PRED_BI | |
| && !general_merge_flag[ x0 ][ y0 ] && !pred_mode_ibc_flag && | |
| cbWidth * cbHeight >= 64 ) | |
| lic_flag[ x0 ][ y0 ] | ae(v) |
| ... | |

The syntax element sps_lic_enabled_flag being 0 specifies that the LIC is disabled; sps_lic_enabled_flag being to 1 specifies that the LIC is enabled.

The syntax element sh_lic_enabled_flag being 1 specifies that the local illumination compensation is enabled in a tile group; sh_lic_enabled_flag being 0 specifies that the local illumination compensation is disabled in a tile group.

The syntax element lic_flag[x0][y0] being 1 specifies that for the current coding unit, when decoding a P or B tile group, local illumination compensation is used to derive the prediction samples of the current coding unit; lic_flag[x0][y0] being 0 specifies that the coding unit is not predicted by applying the local illumination compensation. When lic_flag[x0][y0] is not present, it is inferred to be equal to 0.

In some embodiments, for each block or CU that is coded by using LIC mode, the encoder specifies the scaling and offset parameters. The specified LIC scale and offset parameters are sent to the decoder for decoding the block, either explicitly or implicitly.

### I. Using Original Samples for Computing LIC Parameters

In some embodiments, LIC parameters derivation is performed using luma elements from the original frame and interpolated samples (according to the MV) in the reconstructed reference frame.

In some embodiments, instead of the boundary elements, all or part (subset) of the luma elements at the position of the current CU are used for LIC scale and offset derivation. This way, instead of neighboring samples, all or part (subset) of the samples located within the borders of the current CU in the original frame (also referred to as original block) and interpolated samples (according to the MV) in the reconstructed reference frame are used for LIC scale and offset computation. The computed scale and offset parameters are sent to the decoder.

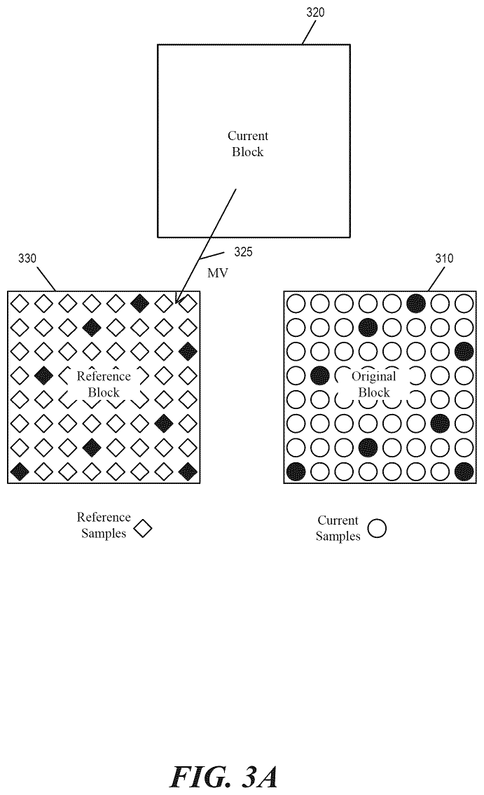

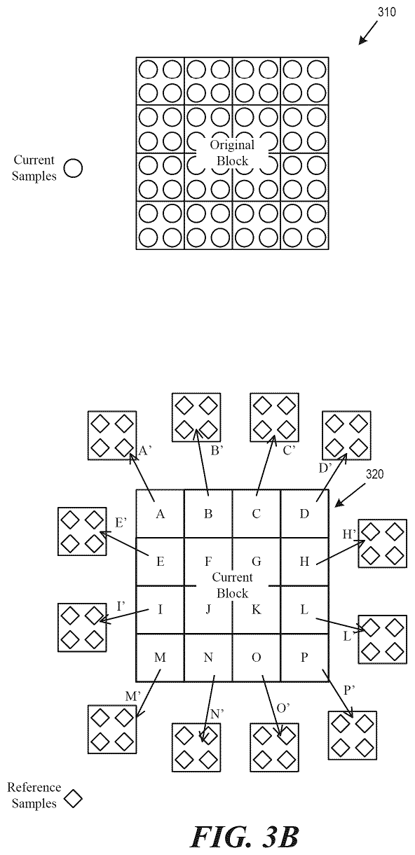

FIGS. 3A-B conceptually illustrate using elements from the original frame and a reference frame to derive the LIC parameters. As illustrated in FIG. 3A, original data from an original block 310 are to be encoded as a current block 320. The current block 320 has a motion vector 325 that references a reference block 330 in a reference frame. (The reference block 330 may also be an interpolated block having interpolated samples.) Thus, instead of using reconstructed samples neighboring top and left boundary of the current block 320 as the current sample, the encoder uses the original data from the original block 310 as the current sample for deriving the scale and offset of the LIC linear model.

Furthermore, the current samples used for deriving the LIC linear model are taken from pixels that are to be encoded as the current block, i.e., original data within the original block 310 that are to become pixels of the current block 320. Pixels in boundary template that are outside of the border of the current block 320 are not used to derive LIC linear model as they are not encoded as part of the current block 320. The corresponding reference samples are analogously taken from within the border of the reference block 330 identified by the motion vector 335 (rather than pixels in boundary template of the reference block.) The current samples used for deriving the LIC linear model may be a subset of the pixels (illustrated as darkened circles) within the original block 310, and the reference samples used for deriving the LIC model may be a corresponding subset of the pixels (illustrated as darkened diamonds) within the reference block 330.

In some embodiments, the current block may be divided into sub-blocks, and each sub-block may have its own motion vector that references its own set of reference pixels (reference sub-block).

The samples of the original block and the samples referenced by motion vectors associated with the sub-blocks of the current block are used to derive the scale parameter and the offset parameter. FIG. 3B shows using original data to deriving LIC parameters when the current block 320 is divided into subblocks. As illustrated, the current block 320 is divided into sub-blocks A-P. Each sub-block has its own motion vector that point to its own reference pixels (illustrated as reference sub-blocks A′-P′, though reference sub-blocks F′, G′, J′, K′ are not shown). The pixels referenced by the subblocks A-P are used as reference samples (may be subsampled). Together with the pixels in the original block 310 as the current samples (may be subsampled), the scale and offset of the LIC linear model parameters are derived for encoding the entire current block 320.

### II. Quantizing Scale and Offset Parameter

In some embodiments, values of the scale and offset parameters used by the linear model to generate the LIC prediction block are selected from pre-defined sets of permissible values. Each set of permissible values has a finite range and is created by sub-sampling a consecutive sequence of numbers uniformly or non-uniformly. In other words, only a subset of the values within the range is used for encoding or decoding. In some embodiments, values of scale and/or offset are limited by a certain range, which is smaller than the original range. In one embodiment, offset values are limited by the [−35; 35] range. In one embodiment, scale values are limited by the [28; 36] range.

In some embodiments, values that can be used for scale and/or offset parameters are subsampled uniformly or non-uniformly. In one embodiment, the uniform subsampling results in keeping only even (or odd values) values. In one embodiment, only even scale values 28, 30, 32, 34, 36 are kept, and values 27, 29, 31, 33, 35 and other remaining values are discarded. In one embodiment, the uniform subsampling results in keeping only values which are multiples of two/three or five. In one embodiment, the result of a non-uniform subsampling is as follows: only offset values which are power of two are used (+/−1, 2, 4, 8, 16, 32, 64, 128, 256). In one embodiment, a subset of the values listed earlier is used. In one embodiment, additional zero offset is added to the list. In one embodiment, the result of a non-uniform subsampling is as follows: values which are multiples of two and three are kept, resulting is following set of values: (+/−1, 2, 3, 6, 12, 24, 48, 96). In one embodiment, a zero offset is added to this list.

In some embodiments, instead of direct coding of scale and offset values, a separate table (or a predefined set of permissible values) is defined at both encoder and decoder, with values assigned to each index, (i.e., an index is used to select a value from the predefined set of permissible values for scale or offset.) In some embodiment, indices from the predefined table are encoded and decoded, instead of the scale and offset values. Table 2A below shows example syntax for sending LIC scale and offset parameters using indices.

TABLE 2A
Syntax for sending LIC parameters using indices

| | Descriptor |
|---|---|
| coding_unit( x0, y0, cbWidth, cbHeight, cqtDepth, treeType, modeType ) { | |
| ... | |
| if(sh_lic_enabled_flag && inter_pred_idc[ x0 ][ y0 ] ! = PRED_BI | |
| && !general_merge_flag[ x0 ][ y0 ] && !pred_mode_ibc_flag && | |
| cbWidth * cbHeight >= 64 ) | |
| lic_flag[ x0 ][ y0 ] | ae(v) |
| if (lic_flag[ x0 ][ y0 ]) { | |
| lic_scale_idx[ x0 ][ y0 ] | |
| lic_offset_idx[ x0 ][ y0 ] | |
| } | |

The syntax element lic_scale_idx[x0][y0] specifies the index of the scale value of local illumination compensation used to derive the prediction samples of the current coding unit. Value of lic_scale_idx[x0][y0] can be one of the following: {0, 1, 2, 3, 4}. When lic_scale_idx[x0][y0] is not present, it is inferred to be equal to 0. Table 2B shows an example table mapping lic_scale_idx to the actual values of LIC scale parameter.

TABLE 2B
Indices for LIC scaling parameter

| lic_scale_idx[ x0 ][ y0 ] | 0 | 1 | 2 | 3 | 4 |
|---|---|---|---|---|---|
| lic_scale[ x0 ][ y0 ] | 32 | 30 | 34 | 28 | 36 |

The syntax element lic_offset_idx[x0][y0] specifies the index of the offset value of local illumination compensation used to derive the prediction samples of the current coding unit. Value of lic_offset_idx[x0][y0] can be one of the following: {0, 1, 2, 3, 4, . . . , 15}. When lic_offset_idx[x0][y0] is not present, it is inferred to be equal to 0. Table 2C shows an example table mapping lic_offset_idx to the actual values of LIC offset parameter.

TABLE 2C
Indices for LIC offset parameter

| lic_offset_idx[ x0 ][ y0 ] | 0 | 1 | 2 | 3 | . . . | 14 | 15 |
|---|---|---|---|---|---|---|---|
| lic_offset[ x0 ][ y0 ] | −1 | 1 | −2 | 2 | . . . | −128 | 128 |

Thus, the tables for scale and offset are arranged in a way which is reflecting the probabilities of the occurrence—more probable values are arranged at the front of the table (smaller indices), and less probable values are moved to the back of the table (larger indices). In other words, a predefined set of permissible values for scale and/or offset are ordered with respect to the index according to probabilities of the permissible values in the set.

Tables 2D and 2E shows example tables of LIC parameters that are arranged based on probability of occurrences.

TABLE 2D
Indices for LIC scale parameter based on probabilities

| lic_scale_idx[ x0 ][ y0 ] | 0 | 1 | 2 | 3 | 4 |
|---|---|---|---|---|---|
| lic_scale[ x0 ][ y0 ] | 30 | 32 | 34 | 36 | 28 |

TABLE 2E
indices for LIC offset parameter based on probabilities

| lic_offset_idx[ x0 ][ y0 ] | 0 | 1 | 2 | 3 | 4 | 5 | . . . | 14 | 15 |
|---|---|---|---|---|---|---|---|---|---|
| lic_offset[ x0 ][ y0 ] | −4 | 4 | 2 | −2 | −8 | 8 | . . . | 128 | −128 |

In some embodiments, adjustable scale/offset values are sent at PPS (picture parameter set) or PH (picture header) or SH (slice header). In some embodiments, a predefined table for scale and/or offset can be updated for each picture or slice; scale_idx and offset_idx from the respective tables are then encoded or decoded.

In some embodiments, multiple scale and/or offset tables can be predefined for the coded sequence and then at each PPS/PH/SH an additional index is encoded or decoded, identifying the number of the predefined scale/offset table currently used. In some embodiments, two indices are encoded or decoded one for scale, another for offset. In some embodiments, two or three indices are encoded or decoded—one for Y and the others are for Cb and/or Cr components.

In some embodiments, scale and offset are encoded or decoded directly, instead of indices of the mapping table. In some embodiments, offset absolute value and offset sign are encoded or decoded separately. Table 3 shows example syntax for sending LIC scale and offset parameters, with absolute values and signs of LIC offsets coded separately.

TABLE 3

| | Descriptor |
|---|---|
| coding_unit( x0, y0, cbWidth, cbHeight, cqtDepth, treeType, modeType ) { | |
| ... | |
| if(sh_lic_enabled_flag && inter_pred_idc[ x0 ][ y0 ] ! = PRED_BI | |
| && !general_merge_flag[ x0 ][ y0 ] && !pred_mode_ibc_flag && | |
| cbWidth * cbHeight >= 64 ) | |
| lic_flag[ x0 ][ y0 ] | ae(v) |
| if (lic_flag[ x0 ][ y0 ]) { | |
| lic_scale [ x0 ][ y0 ] | |
| lic_abs_offset [ x0 ][ y0 ] | |
| if (lic_abs_offset [ x0 ][ y0 ] > 0) | |
| lic_sign_offset[ x0 ][ y0 ] | |
| } | |

The syntax element lic_scale [x0][y0] specifies the scale value of local illumination compensation used to derive the prediction samples of the current coding unit. Value of lic_scale [x0][y0] can be one of the following: {28, 30, 32, 34, 36}. When lic_scale [x0][y0] is not present, it is inferred to be equal to 32 (i.e., no scale).

The syntax element lic_abs_offset [x0][y0] specifies the absolute value for the offset value of local illumination compensation used to derive the prediction samples of the current coding unit. Value of lic_abs_offset[x0][y0] can be one of the following: {0, 1, 2, 4, 8, 16, 32, 64, 128}. When lic_abs_offset [x0][y0] is not present, it is inferred to be equal to 0.

The syntax element lic_sign_offset[x0][y0] specifies the sign of the offset value of local illumination compensation used to derive the prediction samples of the current coding unit. lic_sign_offset[x0][y0] equal to 0 means positive value of lic_offset[x0][y0], lic_sign_offset[x0][y0] equal to 1 means negative value of lic_offset[x0][y0]. When lic_sign_offset[x0][y0] is not present, it is inferred to be equal to 0.

In some embodiments, the reconstructed value for the lic_offset[x0][y0] can be computed as follows:

$$lic\_offset [ x 0 ] [ y 0 ] = {( - 1 )}^{lic \_ sign \_ offset [ x 0 ] [ y 0 ]} * lic\_abs \_offset [ x 0 ] [ y 0 ]$$

In some embodiments. lic_sign_offset[x0][y0] equal to 0 means negative value of lic_offset[x0][y0], lic_sign_offset[x0][y0] equal to 1 means positive value of lic_offset[x0][y0]. In some embodiments, when lic_sign_offset[x0][y0] is not present, it is inferred to be equal to 1.

In some embodiments, the reconstruction for the lic_offset[x0][y0] can be computed as follows:

$$lic\_offset [ x 0 ] [ y 0 ] = {( - 1 )}^{lic \_ sign \_ offset [ x 0 ] [ \overline{y} 0 ] + 1} * lic\_abs \_offset [ x 0 ] [ y 0 ]$$

In some embodiments, only absolute value of the offset is mapped to the values in the table, and the sign is encoded or decoded separately. For some embodiments, example syntax with separately coded sign and absolute values for LIC offset parameters is as shown in Table 4:

TABLE 4

| | Descriptor |
|---|---|
| coding_unit( x0, y0, cbWidth, cbHeight, cqtDepth, treeType, modeType ) { | |
| ... | |
| if(sh_lic_enabled_flag && inter_pred_idc[ x0 ][ y0 ] ! = PRED_BI | |
| && !general_merge_flag[ x0 ][ y0 ] && !pred_mode_ibc_flag && | |
| cbWidth * cbHeight >= 64 ) | |
| lic_flag[ x0 ][ y0 ] | ae(v) |
| if (lic_flag[ x0 ][ y0 ]) { | |
| lic_scale_idx [ x0 ][ y0 ] | |
| lic_abs_offset_idx [ x0 ][ y0 ] | |
| if (lic_abs_offset_idx [ x0 ][ y0 ] > 0) | |
| lic_sign_offset[ x0 ][ y0 ] | |
| } | |

The syntax element lic_scale_idx[x0][y0] specifies the index of the scale value of local illumination compensation used to derive the prediction samples of the current coding unit. Value of lic_scale_idx[x0][y0] can be one of the following: {0, 1, 2, 3, 4}. When lic_scale_idx[x0][y0] is not present, it is inferred to be equal to 0.

| lic_scale_idx[ x0 ][ y0 ] | 0 | 1 | 2 | 3 | 4 |
|---|---|---|---|---|---|
| lic_scale[ x0 ][ y0 ] | 32 | 30 | 34 | 28 | 36 |

The syntax element lic_offset_idx[x0][y0] specifies the index of the offset value of local illumination compensation used to derive the prediction samples of the current coding unit. Value of lic_offset_idx[x0][y0] can be one of the following: {0, 1, 2, 3, 4, . . . , 8}. When lic_offset_idx[x0][y0] is not present, it is inferred to be equal to 0.

| lic_offset_idx[ x0 ][ y0 ] | 0 | 1 | 2 | 3 | 4 | 5 | 6 | 7 | 8 |
|---|---|---|---|---|---|---|---|---|---|
| lic_abs_offset | 0 | 1 | 2 | 4 | 8 | 16 | 32 | 64 | 128 |
| [ x0 ][ y0 ] | | | | | | | | | |

The syntax element lic_sign_offset[x0][y0] specifies the sign of the offset value of local illumination compensation used to derive the prediction samples of the current coding unit. lic_sign_offset[x0][y0] equal to 0 means positive value of lic_offset[x0][y0], lic_sign_offset[x0][y0] equal to 1 means negative value of lic_offset[x0][y0]. When lic_sign_offset[x0][y0] is not present, it is inferred to be equal to 0.

### III. Separate LIC Parameter Values for Chroma Components

In some embodiments, the video coder may use separate LIC parameters for luma and chroma components. In other words, in addition to using luma scale and offset parameters for generating a LIC prediction block for the luma component, the video encoder/decoder may also use separate chroma scale and offset parameters for generating prediction blocks for chroma components. Thus, one additional offset value (for both of the Cb and Cr components) is computed, encoded and decoded. Thus, in some embodiments, the luma and chroma scale parameters are signaled by coding one or more scale parameter indices that select values for the luma and chroma scale parameters, while the luma and chroma offset parameters are signaled by coding one or more offset parameter indices that select values for the luma and chroma offset parameters. For some embodiments, example syntax for using separate luma and chroma LIC parameters is as shown in Table 5:

TABLE 5

| | Descriptor |
|---|---|
| coding_unit( x0, y0, cbWidth, cbHeight, cqtDepth, treeType, modeType ) { | |
| ... | |
| if(sh_lic_enabled_flag && inter_pred_idc[ x0 ][ y0 ] ! = PRED_BI | |
| && !general_merge_flag[ x0 ][ y0 ] && !pred_mode_ibc_flag && | |
| cbWidth * cbHeight >= 64 ) | |
| lic_flag[ x0 ][ y0 ] | ae(v) |
| if (lic_flag[ x0 ][ y0 ]) { | |
| lic_y_scale_idx[ x0 ][ y0 ] | |
| lic_y_offset_idx[ x0 ][ y0 ] | |
| lic_cbcr_offset_idx[ x0 ][ y0 ] | |
| } | |

The syntax element lic_y_scale_idx[x0][y0] specifies the index of the scale value of local illumination compensation used to derive the prediction samples of the current luma coding block. Value of lic_y_scale_idx[x0][y0] can be one of the following: {0, 1, 2, 3, 4}. When lic_y_scale_idx[x0][y0] is not present, it is inferred to be equal to 0.

| lic_y_scale_idx[ x0 ][ y0 ] | 0 | 1 | 2 | 3 | 4 |
|---|---|---|---|---|---|
| lic_y_scale[ x0 ][ y0 ] | 32 | 30 | 34 | 28 | 36 |

The syntax element lic_y_offset_idx[x0][y0] specifies the index of the offset value of local illumination compensation used to derive the prediction samples of the current luma coding block. Value of lic_y_offset_idx[x0][y0] can be one of the following: {0, 1, 2, 3, 4, . . . , 15}. When lic_y_scale_idx[x0][y0] is not present, it is inferred to be equal to 0.

| | lic_y_offset_idx[ x0 ][ y0 ]/ | | | | | | |
|---|---|---|---|---|---|---|---|
| | lic_cbcr_offset_idx[ x0 ][ y0 ](*) | | | | | | |
| | 0 | 1 | 2 | 3 | . . . | 14 | 15 |
| lic_offset[ x0 ][ y0 ] | −1 | 1 | −2 | 2 | . . . | −128 | 128 |

The syntax element lic_cbcr_offset_idx[x0][y0] specifies the index of the offset value of local illumination compensation used to derive the prediction samples of both chroma components of the current coding unit. Value of lic_cbcr_offset_idx[x0][y0] can be one of the following: {0, 1, 2, 3, 4, 15}. When lic_cbcr_scale_idx[x0][y0] is not present, it is inferred to be equal to 0.

| lic_cbcr_offset_idx[ x0 ][ y0 ] | 0 | 1 | 2 | 3 | . . . | 16 | 17 |
|---|---|---|---|---|---|---|---|
| lic_cbcr_offset[ x0 ][ y0 ] | −3 | 3 | −5 | 5 | . . . | −256 | 256 |

In some embodiments, the same value of the lic_y_scale_idx[x0][y0] value defined for luma is reused for chroma components (Cb/Cr or both). In some embodiments, lic_scale_cb/cr/cbcr_idx is set to zero. In some embodiments, the offset is defined for one color component and then reused for another color component. For example, the offset may be defined for Cb and reused for Cr. In some embodiments, the scale is defined for one color component and then reused for another color component. For example, the scale may be defined for Cb and reused for Cr.

In some embodiments, separate values/ranges of scale/offset for Cb and Cr components are supported. In some embodiments, two additional offset values (one for each of the Cb and Cr components) are computed, encoded and decoded. In some embodiments, example syntax having separate LIC parameters for Cb and Cr is as shown in Table 6:

TABLE 6

| | Descriptor |
|---|---|
| coding_unit( x0, y0, cbWidth, cbHeight, cqtDepth, treeType, modeType ) { | |
| ... | |
| if(sh_lic_enabled_flag && inter_pred_idc[ x0 ][ y0 ] ! = PRED_BI | |
| && !general_merge_flag[ x0 ][ y0 ] && !pred_mode_ibc_flag && | |
| cbWidth * cbHeight >= 64 ) | |
| lic_flag[ x0 ][ y0 ] | ae(v) |
| if (lic_flag[ x0 ][ y0 ]) { | |
| lic_y_scale_idx[ x0 ][ y0 ] | |
| lic_y_offset_idx[ x0 ][ y0 ] | |
| lic_cb_offset_idx[ x0 ][ y0 ] | |
| lic_cr_offset_idx[ x0 ][ y0 ] | |
| } | |

The syntax element lic_y_scale_idx[x0][y0] specifies the index of the scale value of local illumination compensation used to derive the prediction samples of the current luma coding block. Value of lic_y_scale_idx[x0][y0] can be one of the following: {0, 1, 2, 3, 4}. When lic_y_scale_idx[x0][y0] is not present, it is inferred to be equal to 0.

The syntax element lic_y_offset_idx[x0][y0] specifies the index of the offset value of local illumination compensation used to derive the prediction samples of the current luma coding block. Value of lic_y_offset_idx[x0][y0] can be one of the following: {0, 1, 2, 3, 4, . . . , 15}. When lic_y_scale_idx[x0][y0] is not present, it is inferred to be equal to 0.

The syntax element lic_cb_offset_idx[x0][y0] specifies the index of the offset value of local illumination compensation used to derive the prediction samples of the Cb component of the current coding unit. Value of lic_cb_offset_idx[x0][y0] can be one of the following: {0, 1, 2, 3, 4, . . . , 15}. When lic_cb_scale_idx[x0][y0] is not present, it is inferred to be equal to 0.

The syntax element lic_cr_offset_idx[x0][y0] specifies the index of the offset value of local illumination compensation used to derive the prediction samples of the Cr component of the current coding unit. Value of lic_cr_offset_idx[x0][y0] can be one of the following: {0, 1, 2, 3, 4, . . . , 15}. When lic_cr_scale_idx[x0][y0] is not present, it is inferred to be equal to 0.

In some embodiments, separate tables with values/ranges of scale/offset for all three or part of Y/Cb/Cr components are defined. In one embodiment, a 3D vector is defined for the offset, where one index provides access to all three offset index values for Y, Cb and Cr, as shown below:

| | lic_y_offset_idx[ x0 ][ y0 ]/ | | | | | | |
|---|---|---|---|---|---|---|---|
| | lic_cb_offset_idx[ x0 ][ y0 ](*)/ | | | | | | |
| | lic_cr_offset_idx[ x0 ][ y0 ](*) | | | | | | |
| | 0 | 1 | 2 | 3 | . . . | 14 | 15 |
| lic_offset[ x0 ][ y0 ] | −1 | 1 | −2 | 2 | . . . | −128 | 128 |

In some embodiments, a 2D vector is defined for the scale, where one index value provides access to both (i) scale index values for Y and (ii) scale index for combined CbCr.

In some embodiments, the same value of the lic_y_scale_idx[x0][y0] defined for luma is reused for chroma components (Cb/Cr or both). In some embodiments, lic_scale_cb/cr/cbcr_idx is set to zero.

In some embodiments, one additional scale value for both of the Cb and Cr components and one additional offset value for both of the Cb and Cr components are computed, encoded and decoded. For some embodiments, example syntax with LIC parameters having the one scale value and one offset value shared by both Cb and Cr components are shown below in Table 7A:

TABLE 7A

| | Descriptor |
|---|---|
| coding_unit( x0, y0, cbWidth, cbHeight, cqtDepth, treeType, modeType ) { | |
| ... | |
| if(sh_lic_enabled_flag && inter_pred_idc[ x0 ][ y0 ] ! = PRED_BI | |
| && !general_merge_flag[ x0 ][ y0 ] && !pred_mode_ibc_flag && | |
| cbWidth * cbHeight >= 64 ) | |
| lic_flag[ x0 ][ y0 ] | ae(v) |
| if (lic_flag[ x0 ][ y0 ]) { | |
| lic_y_scale_idx[ x0 ][ y0 ] | |
| lic_y_offset_idx[ x0 ][ y0 ] | |
| lic_cbcr_scale_idx[ x0 ][ y0 ] | |
| lic_cbcr_offset_idx[ x0 ][ y0 ] | |
| } | |

The syntax element lic_y_scale_idx[x0][y0] specifies the index of the scale value of local illumination compensation used to derive the prediction samples of the current luma coding block. Value of lic_y_scale_idx[x0][y0] can be one of the following: {0, 1, 2, 3, 4}. When lic_y_scale_idx[x0][y0] is not present, it is inferred to be equal to 0.

lic_cbcr_scale_idx[x0][y0] specifies the index of the scale value of local illumination compensation used to derive the prediction samples of both chroma components of the current coding unit. Value of lic_cbcr_scale_idx[x0][y0] can be one of the following: {0, 1, 2, 3, 4}. When lic_cbcr_scale_idx[x0][y0] is not present, it is inferred to be equal to 0.

| lic_y_scale_idx[ x0 ][ y0 ]/ | | | | | |
|---|---|---|---|---|---|
| lic_cbcr_scale_idx [ x0 ][ y0 ](*) | 0 | 1 | 2 | 3 | 4 |
| lic_scale[ x0 ][ y0 ] | 32 | 30 | 34 | 28 | 36 |

lic_y_offset_idx[x0][y0] specifies the index of the offset value of local illumination compensation used to derive the prediction samples of the current luma coding block. Value of lic_y_offset_idx[x0][y0] can be one of the following: {0, 1, 2, 3, 4, . . . , 15}. When lic_y_scale_idx[x0][y0] is not present, it is inferred to be equal to 0.

lic_cbcr_offset_idx[x0][y0] specifies the index of the offset value of local illumination compensation used to derive the prediction samples of both chroma components of the current coding unit. Value of lic_cbcr_offset_idx[x0][y0] can be one of the following: {0, 1, 2, 3, 4, . . . , 15}. When lic_cbcr_offset_idx[x0][0] is not present, it is inferred to be equal to 0.

| | lic_y_offset_idx[ x0 ][ y0 ]/ | | | | | | |
|---|---|---|---|---|---|---|---|
| | lic_cbcr_offset_idx[ x0 ][ y0 ](*) | | | | | | |
| | 0 | 1 | 2 | 3 | . . . | 14 | 15 |
| lic_offset[ x0 ][ y0 ] | −1 | 1 | −2 | 2 | . . . | −128 | 128 |

In some embodiments, one or both of the scale/offset values are defined for one color component and then this value is reused for another color component. For example, in some embodiment, when one or both of the scale/offset values are defined for Cb, these defined values are reused for Cr.

In some embodiments, separate tables with values/ranges of scale/offset for all three or part of Y/Cb/Cr components are defined. In some embodiments, a 3D vector is defined for the offset, where one index provides access to all three offset index values for Y, Cb and Cr. In some embodiments, the 3D vector can be written down as follows:

| lic_offset_idx[ x0 ][ y0 ] | 0 | 1 | 2 | 3 | . . . | 14 | 15 |
|---|---|---|---|---|---|---|---|
| lic_y_offset[ x0 ][ y0 ] | −1 | 1 | −2 | 2 | . . . | −128 | 128 |
| lic_cb_offset[ x0 ][ y0 ] | 0 | −4 | −2 | 4 | | −64 | 64 |
| lic_cr_offset[ x0 ][ y0 ] | 0 | 2 | −4 | 4 | . . . | 256 | −256 |

When one index lic_offset_idx[x0][y0] is decoded, this value is then mapped to the corresponding values of lic_y_offset[x0][y0], lic_cb_offset[x0][y0] and lic_cr_offset[x0][y0]. In some embodiments these values are differently arranged for each of the Y/Cb/Cr component, depending on the probability of certain offset value for the corresponding color component. In some embodiments, a similar table is used for scale.

In some embodiments, one additional scale value (for both of the Cb and Cr components) and two additional offset values (one for each of the Cb and Cr components) are computed, encoded and decoded. For some embodiments, example syntax with the one scale value for both Cb and Cr and two offset values for Cb and Cr respectively are shown below in Table 7B:

TABLE 7B

| | Descriptor |
|---|---|
| coding_unit( x0, y0, cbWidth, cbHeight, cqtDepth, treeType, modeType ) { | |
| ... | |
| if(sh_lic_enabled_flag && inter_pred_idc[ x0 ][ y0 ] ! = PRED_BI | |
| && !general_merge_flag[ x0 ][ y0 ] && !pred_mode_ibc_flag && | |
| cbWidth * cbHeight >= 64 ) | |
| lic_flag[ x0 ][ y0 ] | ae(v) |
| if (lic_flag[ x0 ][ y0 ]) { | |
| lic_y_scale_idx[ x0 ][ y0 ] | |
| lic_y_offset_idx[ x0 ][ y0 ] | |
| lic_cbcr_scale_idx[ x0 ][ y0 ] | |
| lic_cb_offset_idx[ x0 ][ y0 ] | |
| lic_cr_offset_idx[ x0 ][ y0 ] | |
| } | |

The syntax element lic_y_scale_idx[x0][y0] specifies the index of the scale value of local illumination compensation used to derive the prediction samples of the current luma coding block. Value of lic_y_scale_idx[x0][y0] can be one of the following: {0, 1, 2, 3, 4}. When lic_y_scale_idx[x0][y0] is not present, it is inferred to be equal to 0.

The syntax element lic_cbcr_scale_idx[x0][y0] specifies the index of the scale value of local illumination compensation used to derive the prediction samples of both chroma components of the current coding unit. Value of lic_cbcr_scale_idx[x0][y0] can be one of the following: {0, 1, 2, 3, 4}. When lic_cbcr_scale_idx[x0][y0] is not present, it is inferred to be equal to 0.

| lic_scale_idx[ x0 ][ y0 ]/ | | | | | |
|---|---|---|---|---|---|
| lic_cbcr_scale_idx[ x0 ][ y0 ](*) | 0 | 1 | 2 | 3 | 4 |
| lic_scale[ x0 ][ y0 ] | 32 | 30 | 34 | 28 | 36 |

The syntax element lic_y_offset_idx[x0][y0] specifies the index of the offset value of local illumination compensation used to derive the prediction samples of the current luma coding block. Value of lic_y_offset_idx[x0][y0] can be one of the following: {0, 1, 2, 3, 4, . . . , 15}. When lic_y_scale_idx[x0][y0] is not present, it is inferred to be equal to 0.

The syntax element lic_cb_offset_idx[x0][y0] specifies the index of the offset value of local illumination compensation used to derive the prediction samples of the Cb component of the current coding unit. Value of lic_cb_offset_idx[x0][y0] can be one of the following: {0, 1, 2, 3, 4, . . . , 15}. When lic_cb_scale_idx[x0][y0] is not present, it is inferred to be equal to 0.

The syntax element lic_cr_offset_idx[x0][y0] specifies the index of the offset value of local illumination compensation used to derive the prediction samples of the Cr component of the current coding unit. Value of lic_cr_offset_idx[x0][y0] can be one of the following: {0, 1, 2, 3, 4, . . . , 15}. When lic_cr_scale_idx[x0][y0] is not present, it is inferred to be equal to 0.

| | lic_y_offset_idx[ x0 ][ y0 ]/ | | | | | | |
|---|---|---|---|---|---|---|---|
| | lic_cb_offset_idx[ x0 ][ y0 ](*)/ | | | | | | |
| | lic_cr_offset_idx[ x0 ][ y0 ](*) | | | | | | |
| | 0 | 1 | 2 | 3 | . . . | 14 | 15 |
| lic_offset[ x0 ][ y0 ] | −1 | 1 | −2 | 2 | . . . | −128 | 128 |

In some embodiments, two scale values (one for each of the Cb and Cr components) and two offset values (one for each of the Cb and Cr components) are computed, encoded and decoded for the chroma components. In some embodiments, example syntax with two scale values and two offset values for Cb and Cr components is shown in Table 8:

TABLE 8

| | Descriptor |
|---|---|
| coding_unit( x0, y0, cbWidth, cbHeight, cqtDepth, treeType, modeType ) { | |
| ... | |
| if(sh_lic_enabled_flag && inter_pred_idc[ x0 ][ y0 ] ! = PRED_BI | |
| && !general_merge_flag[ x0 ][ y0 ] && !pred_mode_ibc_flag && | |
| cbWidth * cbHeight >= 64 ) | |
| lic_flag[ x0 ][ y0 ] | ae(v) |
| if (lic_flag[ x0 ][ y0 ]) { | |
| lic_y_scale_idx[ x0 ][ y0 ] | |
| lic_y_offset_idx[ x0 ][ y0 ] | |
| lic_cb_scale_idx[ x0 ][ y0 ] | |
| lic_cb_offset_idx[ x0 ][ y0 ] | |
| lic_cr_scale_idx[ x0 ][ y0 ] | |
| lic_cr_offset_idx[ x0 ][ y0 ] | |
| } | |

The syntax element lic_y_scale_idx[x0][y0] specifies the index of the scale value of local illumination compensation used to derive the prediction samples of the current luma coding block. Value of lic_y_scale_idx[x0][y0] can be one of the following: {0, 1, 2, 3, 4}. When lic_y_scale_idx[x0][y0] is not present, it is inferred to be equal to 0.

The syntax element lic_cb_scale_idx[x0][y0] specifies the index of the scale value of local illumination compensation used to derive the prediction samples of the Cb component of the current coding unit. Value of lic_cb_scale_idx[x0][y0] can be one of the following: {0, 1, 2, 3, 4}. When lic_cb_scale_idx[x0][y0] is not present, it is inferred to be equal to 0.

The syntax element lic_cr_scale_idx[x0][y0] specifies the index of the scale value of local illumination compensation used to derive the prediction samples of the Cr component of the current coding unit. Value of lic_cr_scale_idx[x0][y0] can be one of the following: {0, 1, 2, 3, 4}. When lic_cr_scale_idx[x0][y0] is not present, it is inferred to be equal to 0.

| lic_scale_idx[ x0 ][ y0 ]/ | | | | | |
|---|---|---|---|---|---|
| lic_cb_scale_idx[ x0 ][ y0 ](*)/ | | | | | |
| lic_cr_scale_idx[ x0 ][ y0 ](*) | 0 | 1 | 2 | 3 | 4 |
| lic_scale[ x0 ][ y0 ] | 32 | 30 | 34 | 28 | 36 |

The syntax element lic_y_offset_idx[x0][y0] specifies the index of the offset value of local illumination compensation used to derive the prediction samples of the current luma coding block. Value of lic_y_offset_idx[x0][y0] can be one of the following: {0, 1, 2, 3, 4, . . . , 15}. When lic_y_scale_idx[x0][y0] is not present, it is inferred to be equal to 0.

The syntax element lic_cb_offset_idx[x0][y0] specifies the index of the offset value of local illumination compensation used to derive the prediction samples of the Cb component of the current coding unit. Value of lic_cb_offset_idx[x0][y0] can be one of the following: {0, 1, 2, 3, 4, . . . , 15}. When lic_cb_offset_idx[x0][y0] is not present, it is inferred to be equal to 0. The syntax element lic_cr_offset_idx[x0][y0] specifies the index of the offset value of local illumination compensation used to derive the prediction samples of the Cr component of the current coding unit. Value of lic_cr_offset_idx[x0][y0] can be one of the following: {0, 1, 2, 3, 4, . . . , 15}. When lic_cr_offset_idx[x0][y0] is not present, it is inferred to be equal to 0.

| | lic_y_offset_idx[ x0 ][ y0 ]/ | | | | | | |
|---|---|---|---|---|---|---|---|
| | lic_cb_offset_idx[ x0 ][ y0 ](*)/ | | | | | | |
| | lic_cr_offset_idx[ x0 ][ y0 ](*) | | | | | | |
| | 0 | 1 | 2 | 3 | . . . | 14 | 15 |
| lic_offset[ x0 ][ y0 ] | −1 | 1 | −2 | 2 | . . . | −128 | 128 |

In some embodiments, separate tables with values/ranges of scale/offset for all three or part of Y/Cb/Cr components are defined. In some embodiments, a 3D vector is defined for the scale/offset, where one index provides access to all three scale/offset index values for Y, Cb and Cr.

In some embodiments, a difference between luma scale/offset index and corresponding chroma (Cb/Cr) scale/offset index is encoded. In some embodiments, scale/offset index are encoded for one color component and a difference between the corresponding scale/offset indices for the other chroma component is encoded in addition. For some embodiments, example syntax with differentially coded LIC scale or offset index for luma and chroma components is shown in Table 9A:

TABLE 9A

| | Descriptor |
|---|---|
| coding_unit( x0, y0, cbWidth, cbHeight, cqtDepth, treeType, modeType ) { | |
| ... | |
| if(sh_lic_enabled_flag && inter_pred_idc[ x0 ][ y0 ] ! = PRED_BI | |
| && !general_merge_flag[ x0 ][ y0 ] && !pred_mode_ibc_flag && | |
| cbWidth * cbHeight >= 64 ) | |
| lic_flag[ x0 ][ y0 ] | ae(v) |
| if (lic_flag[ x0 ][ y0 ]) { | |
| lic_y_scale_idx[ x0 ][ y0 ] | |
| lic_y_offset_idx[ x0 ][ y0 ] | |
| delta_lic_cb_scale_idx[ x0 ][ y0 ] | |
| delta_lic_cb_offset_idx[ x0 ][ y0 ] | |
| delta_lic_cr_scale_idx[ x0 ][ y0 ] | |
| delta_lic_cr_offset_idx[ x0 ][ y0 ] | |
| } | |

The syntax element delta_lic_cb_scale_idx[x0][y0] specifies the difference between the index of the scale value of local illumination compensation used to derive the prediction samples of Y and the index of the scale value of local illumination compensation used to derive the prediction samples of Cb component of the current coding unit. Value of delta_lic_cb_scale_idx[x0][y0] can be one of the following: {0, +/−1, +/−2, +/−3, +/−4}. When delta_lic_cb_scale_idx[x0][y0] is not present, it is inferred to be equal to 0.

The syntax element delta_lic_cr_scale_idx[x0][y0] specifies the difference between the index of the scale value of local illumination compensation used to derive the prediction samples of Y and the index of the scale value of local illumination compensation used to derive the prediction samples of Cr component of the current coding unit. Value of delta_lic_cr_scale_idx[x0][y0] can be one of the following: {0, +/−1, +/−2, +/−3, +/−4}. When delta_lic_cr_scale_idx[x0][y0] is not present, it is inferred to be equal to 0.

The syntax element delta_lic_cb_offset_idx[x0][y0] specifies the difference between the index of the offset value of local illumination compensation used to derive the prediction samples of Y component and the index of the offset value of local illumination compensation used to derive the prediction of Cb samples component of the current coding unit. Value of delta_lic_cb_offset_idx[x0][y0] can be one of the following: {0, +/−1, +/−2, +/−3, +/−4, . . . , +/−15}. When delta_lic_cb_offset_idx[x0][y0] is not present, it is inferred to be equal to 0.

The syntax element delta_lic_cr_offset_idx[x0][y0] specifies the difference between the index of the offset value of local illumination compensation used to derive the prediction samples of Y component and the index of the offset value of local illumination compensation used to derive the prediction samples of Cr component of the current coding unit. Value of delta_lic_cr_offset_idx[x0][y0] can be one of the following: {0, +/−1, +/−2, +/−3, +/−4, . . . , +/−15}. When delta_lic_cr_offset_idx[x0][y0] is not present, it is inferred to be equal to 0.

For some embodiments, the LIC syntax with differentially coded scale or offset index for luma and chroma components is shown in Table 9B:

TABLE 9B

| | Descriptor |
|---|---|
| coding_unit( x0, y0, cbWidth, cbHeight, cqtDepth, treeType, modeType ) { | |
| ... | |
| if(sh_lic_enabled_flag && inter_pred_idc[ x0 ][ y0 ] ! = PRED_BI | |
| && !general_merge_flag[ x0 ][ y0 ] && !pred_mode_ibc_flag && | |
| cbWidth * cbHeight >= 64 ) | |
| lic_flag[ x0 ][ y0 ] | ae(v) |
| if (lic_flag[ x0 ][ y0 ]) { | |
| lic_y_scale_idx[ x0 ][ y0 ] | |
| lic_y_offset_idx[ x0 ][ y0 ] | |
| lic_cb_scale_idx[ x0 ][ y0 ] | |
| lic_cb_offset_idx[ x0 ][ y0 ] | |
| delta_lic_cr_scale_idx[ x0 ][ y0 ] | |
| delta_lic_cr_offset_idx[ x0 ][ y0 ] | |
| } | |

The syntax element delta_lic_cr_scale_idx[x0][y0] specifies the difference between the index of the scale value of local illumination compensation used to derive the prediction samples of Cb and the index of the scale value of local illumination compensation used to derive the prediction samples of Cr component of the current coding unit. Value of delta_lic_cr_scale_idx[x0][y0] can be one of the following: {0, +/−1, +/−2, +/−3, +/−4}. When delta_lic_cr_scale_idx[x0][y0] is not present, it is inferred to be equal to 0.

The syntax element delta_lic_cr_offset_idx[x0][y0] specifies the difference between the index of the offset value of local illumination compensation used to derive the prediction samples of Cb component and the index of the offset value of local illumination compensation used to derive the prediction samples of Cr component of the current coding unit. Value of delta_lic_cr_offset_idx[x0][y0] can be one of the following: {0, +/−1, +/−2, +/−3, +/−4, . . . , +/−15}. When delta_lic_cr_offset_idx[x0][y0] is not present, it is inferred to be equal to 0.

In some embodiments, delta coding is applied to directly encode or decode values of scale and/or offset, instead of indices of the mapping table(s). In some embodiments, a difference between the LIC scale and/or offset for Y component and corresponding LIC scale and/or offset for Cb component are encoded/decoded. In one embodiment, a difference between the LIC scale and/or offset for Y component and corresponding LIC scale and/or offset for Cr component are encoded or decoded. In one embodiment, a difference between the LIC scale and/or offset for Cb component and corresponding LIC scale and/or offset for Cr component are encoded or decoded. For some embodiments, example syntax with directly coded LIC scale and offset parameter values luma and chroma components is shown in Table 10:

TABLE 10

| | Descriptor |
|---|---|
| coding_unit( x0, y0, cbWidth, cbHeight, cqtDepth, treeType, modeType ) { | |
| ... | |
| if(sh_lic_enabled_flag && inter_pred_idc[ x0 ][ y0 ] ! = PRED_BI | |
| && !general_merge_flag[ x0 ][ y0 ] && !pred_mode_ibc_flag && | |
| cbWidth * cbHeight >= 64 ) | |
| lic_flag[ x0 ][ y0 ] | ae(v) |
| if (lic_flag[ x0 ][ y0 ]) { | |
| lic_y_scale[ x0 ][ y0 ] | |
| lic_y_offset [ x0 ][ y0 ] | |
| delta_lic_cb_scale [ x0 ][ y0 ] | |
| delta_lic_cb_offset [ x0 ][ y0 ] | |
| delta_lic_cr_scale [ x0 ][ y0 ] | |
| delta_lic_cr_offset [ x0 ][ y0 ] | |
| } | |

The syntax element delta_lic_cb_scale [x0][y0] specifies the difference between the scale value of local illumination compensation used to derive the prediction samples of Y and the scale value of local illumination compensation used to derive the prediction samples of Cb component of the current coding unit. Value of delta_lic_cb_scale[x0][y0] can be one of the following: {0, +/−1, +/−2, +/−3, +/−4}. When delta_lic_cb_scale[x0][y0] is not present, it is inferred to be equal to 0.

The syntax element delta_lic_cr_scale_idx[x0][y0] specifies the difference between the scale value of local illumination compensation used to derive the prediction samples of Y and the scale value of local illumination compensation used to derive the prediction samples of Cr component of the current coding unit. Value of delta_lic_cr_scale [x0][y0] can be one of the following: {0, +/−1, +/−2, +/−3, +/−4}. When delta_lic_cr_scale [x0][y0] is not present, it is inferred to be equal to 0.

The syntax element delta_lic_cb_offset [x0][y0] specifies the difference between the offset value of local illumination compensation used to derive the prediction samples of Y component and the offset value of local illumination compensation used to derive the prediction samples of Cb component of the current coding unit. Value of delta_lic_cb_offset [x0][y0] can be one of the following: {0, +/−1, +/−2, +/−3, +/−4, . . . , +/−15}. When delta_lic_cb_offset [x0][y0] is not present, it is inferred to be equal to 0.

The syntax element delta_lic_cr_offset [x0][y0] specifies the difference between the offset value of local illumination compensation used to derive the prediction samples of Y component and the offset value of local illumination compensation used to derive the prediction samples of Cr component of the current coding unit. Value of delta_lic_cr_offset [x0][y0] can be one of the following: {0, +/−1, +/−2, +/−3, +/−4, . . . , +/−15}. When delta_lic_cr_offset [x0][y0] is not present, it is inferred to be equal to 0.

In some embodiments, for one/all or subset of the values (lic_y_scale[x0][y0], lic_y_offset [x0] [y0], delta_lic_cb_scale [x0][y0], delta_lic_cr_scale [x0][y0], delta_lic_cb_offset [x0][y0], delta_lic_cr_offset [x0][y0]), absolute value and sign are encoded or decoded separately, as it is described in the section above. In some embodiments, if the delta_lic_cb/cr_scale [x0][y0] is equal to zero, then the sign for the delta is not encoded or decoded. In some embodiments, the same rule is applied for Y component. In some embodiment, values of the scale and/or offset are en/decoded directly, and for one/all or subset of the values (lic_y_scale [x0][y0], lic_cb_scale [x0][y0], lic_cr_scale [x0][y0]) a difference between the most probable scale value and the current value is en/decoded. In some embodiments, the most probable scale value is 32 (no scale) and a difference between 32 and one, two or all of the lic_y_scale [x0][y0], lic_cb_scale [x0][y0], lic_cr_scale [x0] [y0] is encoded or decoded. In some embodiments, similar approach is applied to the offset coding.

IV. History-Based Table with LIC Scale and Offset Parameters

In some embodiments, LIC scale and offset values from the previously decoded CUs are stored in the separate table, and then those values can be used for the current CU as an alternative to the defined and encoded/decoded LIC scale and offset values. In this case, only index from the history-based table would need to be transmitted. In some embodiments, the index is used to select an entry from one or more entries of the history-based table. Each entry of the history-based table includes a historical scale parameter value and an offset parameter value that were applied to generate a prediction block for encoding or decoding a previous block that used LIC.

The history-based table used to store LIC parameters will be updated after coding one CU coded with LIC flag equal to one (or true). In some embodiments, the video encoder/decoder updates the history-based table with a new entry that includes a scale parameter value and an offset parameter value that are used to generate the prediction block for encoding or decoding the current CU. In some embodiments, this history-based table has a fixed size with predefined values, and it is updated during the encoding or decoding process.

To avoid undefined cases, when the CU is the first CU in the CTU, the LIC flag is set to one or assumed to be one. For some embodiments, example syntax for coding LIC parameters using history-based tables is shown in Table 11:

TABLE 11

| | Descriptor |
|---|---|
| coding_unit( x0, y0, cbWidth, cbHeight, cqtDepth, treeType, modeType ) { | |
| ... | |
| if(sh_lic_enabled_flag && inter_pred_idc[ x0 ][ y0 ] ! = PRED_BI | |
| && !general_merge_flag[ x0 ][ y0 ] && !pred_mode_ibc_flag && | |
| cbWidth * cbHeight >= 64 ) | |
| lic_flag[ x0 ][ y0 ] | ae(v) |
| if (lic_flag[ x0 ][ y0 ]) | |
| lic_params_encoded_flag[ x0 ][ y0 ] | |
| if (lic_params_encoded_flag[ x0 ][ y0 ]) { | |
| lic_scale_idx[ x0 ][ y0 ] | |
| lic_offset_idx[ x0 ][ y0 ] | |
| } | |
| else | |
| lic_hb_idx[ x0 ][ y0 ] | |

The syntax element lic_params_encoded_flag [x0][y0] equal to 1 specifies that for the current coding unit, when decoding a P or B tile group, local illumination compensation is used to derive the prediction samples of the current coding unit and scale and offset values are sent to the decoder. lic_params_encoded_flag [x0][y0] equal to 0 specifies that the scale and offset values for applying the local illumination compensation are defined from the history-based table. When lic_params_encoded_flag [x0][y0] is not present, it is inferred to be equal to 0.

The syntax element lic_scale_idx[x0][y0] specifies the index of the scale value of local illumination compensation used to derive the prediction samples of the current coding unit. Value of lic_scale_idx[x0][y0] can be one of the following: {0, 1, 2, 3, 4}. When lic_scale_idx[x0][y0] is not present, it is inferred to be equal to 0.

The syntax element lic_offset_idx[x0][y0] specifies the index of the offset value of local illumination compensation used to derive the prediction samples of the current coding unit. Value of lic_offset_idx[x0][y0] can be one of the following: {0, 1, 2, 3, 4, . . . , 15}. When lic_scale_idx[x0][y0] is not present, it is inferred to be equal to 0.

The syntax element lic_hb_idx[x0][y0] specifies the index of the scale/offset set of local illumination compensation parameters used to derive the prediction samples of the current coding unit. Value of lic_hb_idx[x0][y0] can be one of the following: {0, 1, . . . , MaxNumLicParams}.

In some embodiments, the history-based table is defined for Y/Cb/Cr components separately, as shown in Table 12 below.

TABLE 12

| | Descriptor |
|---|---|
| coding_unit( x0, y0, cbWidth, cbHeight, cqtDepth, treeType, modeType ) { | |
| ... | |
| if(sh_lic_enabled_flag && inter_pred_idc[ x0 ][ y0 ] ! = PRED_BI | |
| && !general_merge_flag[ x0 ][ y0 ] && !pred_mode_ibc_flag && | |
| cbWidth * cbHeight >= 64 ) | |
| lic_flag[ x0 ][ y0 ] | ae(v) |
| if (lic_flag[ x0 ][ y0 ]) | |
| lic_params_encoded_flag[ x0 ][ y0 ] | |
| if (lic_params_encoded_flag[ x0 ][ y0 ]) { | |
| lic_y_scale_idx[ x0 ][ y0 ] | |
| lic_y_offset_idx[ x0 ][ y0 ] | |
| lic_cb_scale_idx[ x0 ][ y0 ] | |
| lic_cb_offset_idx[ x0 ][ y0 ] | |
| lic_cr_scale_idx[ x0 ][ y0 ] | |
| lic_cr_offset_idx[ x0 ][ y0 ] | |
| } | |
| else { | |
| lic_y_hb_idx[ x0 ][ y0 ] | |
| lic_cb_hb_idx[ x0 ][ y0 ] | |
| lic_cr_hb_idx[ x0 ][ y0 ] | |
| } | |

The syntax element lic_y_hb_idx[x0][y0] specifies the index of the scale/offset set of local illumination compensation parameters used to derive the prediction samples of Y component of the current coding unit. Value of lic_y_hb_idx[x0][y0] can be one of the following: {0, 1, . . . , MaxNumLicParamsY}. The syntax element lic_cb_hb_idx[x0][y0] specifies the index of the scale/offset set of local illumination compensation parameters used to derive the prediction samples of Cb component of the current coding unit. Value of lic_cb_hb_idx[x0][y0] can be one of the following: {0, 1, . . . , MaxNumLicParamsCb}.

The syntax element lic_cr_hb_idx[x0][y0] specifies the index of the scale/offset set of local illumination compensation parameters used to derive the prediction samples of Cr component of the current coding unit. Value of lic_cr_hb_idx[x0][y0] can be one of the following: {0, 1, . . . , MaxNumLicParamsCr}.

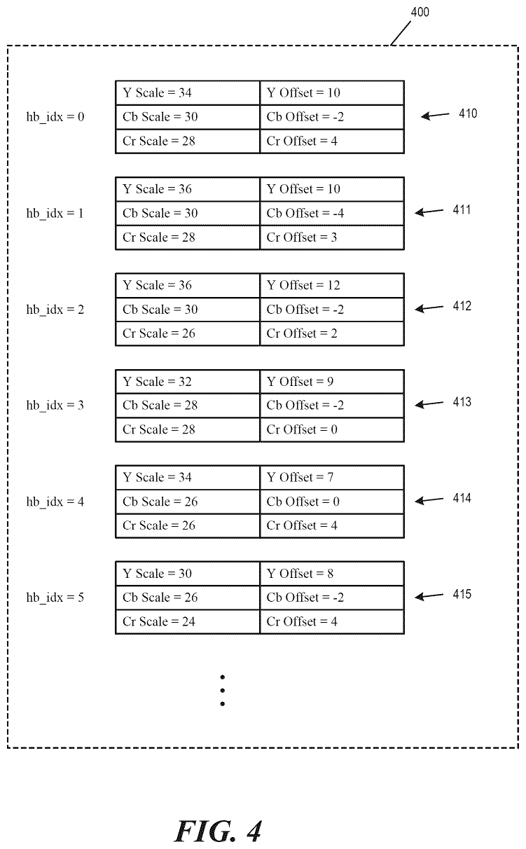

FIG. 4 illustrates a history-based table 400 that provides previously used LIC scale and offset parameter values for use by the current block. The history-based table 400 has several entries 410-415 that correspond to the history-based table index (hb_idx) being 0 through 5. Each entry corresponds to a previous LIC coded block and contains the LIC parameters used for that previously coded block. Each entry contains a scale value for Y component, a scale value for Cb component, a scale value for Cr component, an offset value for Y component, an offset value for Cb component, and an offset value for Cr component. When encoding or decoding the current block, the video encoder or decoder may set the history-based table index to select and retrieve one entry from the history-based table 400. The retrieved parameters are then used to determine the LIC prediction blocks of the three components.

The example history-based table 400 includes separate values for Y, Cb, and Cr components, respectively. In some embodiments, one history-based table is shared by all three Y/Cb/Cr components. In some embodiments, a separate history-based table is constructed for each Y/Cb/Cr component. In some embodiments, one entry in the history-based table contains LIC parameters for all three Y/Cb/Cr components. In this case, only one index lic_hb_idx[x0][y0] is required. In some embodiments, the meaning of the lic_params_encoded_flag is inverted and scale and offset values are signalled when the flag is equal to zero.

In some embodiments, one, two, or a subset of lic_y_scale[x0][y0], lic_y_offset [x0][y0], lic_cb_scale[x0][y0], lic_cb_offset [x0][y0], lic_cr_scale[x0][y0], lic_cr_offset [x0][y0]) are encoded or decoded by value instead of using a mapping table, and a history-based table is constructed. In one embodiment, elements from the constructed history-based table are used as prediction blocks for one, two or a subset of the encoded or decoded lic_y_scale[x0][y0], lic_y_offset [x0][y0], lic_cb_scale[x0][y0], lic_cb_offset [x0][y0], lic_cr_scale[x0][y0], lic_cr_offset [x0][y0]. In some embodiment, an index from the history-based table and additional delta are encoded or decoded for one/two or a subset of the encoded or decoded lic_y_scale[x0][y0], lic_y_offset [x0][y0], lic_cb_scale[x0][y0], lic_cb_offset [x0][y0], lic_cr_scale[x0][y0], lic_cr_offset[x0][y0].

In some embodiments, each element or entry of the history-based table contains both, scale and offset values. In some embodiments, one index for the history-based table and two delta values (e.g., delta values relative to the scale/offset values stored in the history-based table) are encoded or decoded for one, two, or all of Y/Cb/Cr components. In some embodiments, a separate history-based table is constructed for scale and/or offset. In some embodiment, a separate history-based table is constructed for one, two or all of the Y/Cb/Cr components.

In some embodiments, a delta value can be additionally defined and signaled to the decoder to be decoded. In some embodiments, if the delta is greater than zero, then the sign for the additional delta is encoded/decoded. Otherwise, the sign is skipped and not signaled at the encoder and skipped during the decoding process. In some embodiments, if the scale value is equal to 32 (i.e., no scaling), the offset value equal to 0 is disallowed at encoder and/or decoder.

In some embodiments, the LIC flag, scale and offset values/indices for one, two or all of the Y/Cb/Cr components are included in the derivation process for motion vector components and reference indices.

### V. Example Video Encoder

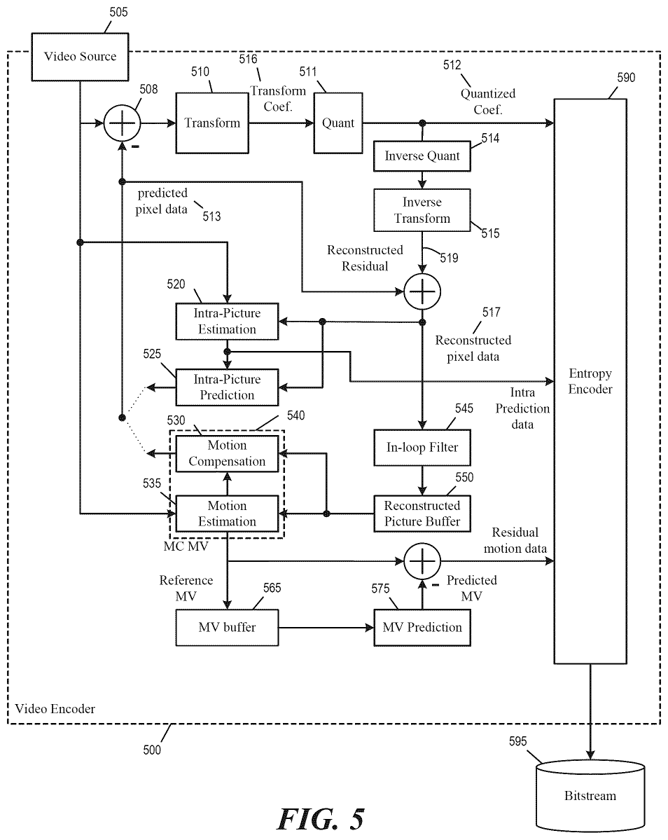

FIG. 5 illustrates an example video encoder 500 that may implement local illumination compensation (LIC) mode. As illustrated, the video encoder 500 receives input video signal from a video source 505 and encodes the signal into bitstream 595. The video encoder 500 has several components or modules for encoding the signal from the video source 505, at least including some components selected from a transform module 510, a quantization module 511, an inverse quantization module 514, an inverse transform module 515, an intra-picture estimation module 520, an intra-prediction module 525, a motion compensation module 530, a motion estimation module 535, an in-loop filter 545, a reconstructed picture buffer 550, a MV buffer 565, and a MV prediction module 575, and an entropy encoder 590. The motion compensation module 530 and the motion estimation module 535 are part of an inter-prediction module 540.

In some embodiments, the modules 510-590 are modules of software instructions being executed by one or more processing units (e.g., a processor) of a computing device or electronic apparatus. In some embodiments, the modules 510-590 are modules of hardware circuits implemented by one or more integrated circuits (ICs) of an electronic apparatus. Though the modules 510-590 are illustrated as being separate modules, some of the modules can be combined into a single module.

The video source 505 provides a raw video signal that presents pixel data of each video frame without compression. A subtractor 508 computes the difference between the raw video pixel data of the video source 505 and the predicted pixel data 513 from the motion compensation module 530 or intra-prediction module 525. The transform module 510 converts the difference (or the residual pixel data or residual signal 508) into transform coefficients (e.g., by performing Discrete Cosine Transform, or DCT). The quantization module 511 quantizes the transform coefficients into quantized data (or quantized coefficients) 512, which is encoded into the bitstream 595 by the entropy encoder 590.

The inverse quantization module 514 de-quantizes the quantized data (or quantized coefficients) 512 to obtain transform coefficients, and the inverse transform module 515 performs inverse transform on the transform coefficients to produce reconstructed residual 519. The reconstructed residual 519 is added with the predicted pixel data 513 to produce reconstructed pixel data 517. In some embodiments, the reconstructed pixel data 517 is temporarily stored in a line buffer (not illustrated) for intra-picture prediction and spatial MV prediction. The reconstructed pixels are filtered by the in-loop filter 545 and stored in the reconstructed picture buffer 550. In some embodiments, the reconstructed picture buffer 550 is a storage external to the video encoder 500. In some embodiments, the reconstructed picture buffer 550 is a storage internal to the video encoder 500.

The intra-picture estimation module 520 performs intra-prediction based on the reconstructed pixel data 517 to produce intra prediction data. The intra-prediction data is provided to the entropy encoder 590 to be encoded into bitstream 595. The intra-prediction data is also used by the intra-prediction module 525 to produce the predicted pixel data 513.

The motion estimation module 535 performs inter-prediction by producing MVs to reference pixel data of previously decoded frames stored in the reconstructed picture buffer 550. These MVs are provided to the motion compensation module 530 to produce predicted pixel data.

Instead of encoding the complete actual MVs in the bitstream, the video encoder 500 uses MV prediction to generate predicted MVs, and the difference between the MVs used for motion compensation and the predicted MVs is encoded as residual motion data and stored in the bitstream 595.

The MV prediction module 575 generates the predicted MVs based on reference MVs that were generated for encoding previously video frames, i.e., the motion compensation MVs that were used to perform motion compensation. The MV prediction module 575 retrieves reference MVs from previous video frames from the MV buffer 565. The video encoder 500 stores the MVs generated for the current video frame in the MV buffer 565 as reference MVs for generating predicted MVs.

The MV prediction module 575 uses the reference MVs to create the predicted MVs. The predicted MVs can be computed by spatial MV prediction or temporal MV prediction. The difference between the predicted MVs and the motion compensation MVs (MC MVs) of the current frame (residual motion data) are encoded into the bitstream 595 by the entropy encoder 590.

The entropy encoder 590 encodes various parameters and data into the bitstream 595 by using entropy-coding techniques such as context-adaptive binary arithmetic coding (CABAC) or Huffman encoding. The entropy encoder 590 encodes various header elements, flags, along with the quantized transform coefficients 512, and the residual motion data as syntax elements into the bitstream 595. The bitstream 595 is in turn stored in a storage device or transmitted to a decoder over a communications medium such as a network.

The in-loop filter 545 performs filtering or smoothing operations on the reconstructed pixel data 517 to reduce the artifacts of coding, particularly at boundaries of pixel blocks. In some embodiments, the filtering operation performed includes sample adaptive offset (SAO). In some embodiment, the filtering operations include adaptive loop filter (ALF).

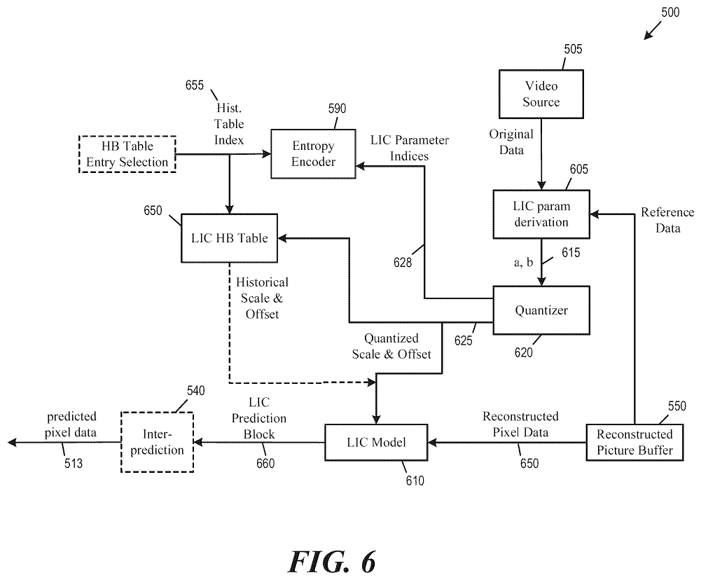

FIG. 6 illustrates portions of the video encoder 500 that implement LIC mode. As illustrated, a LIC parameter derivation module 605 receives original data from the video source 505 and reference data from the reconstructed picture buffer 550. The reference data from the reconstructed picture buffer 550 may be retrieved based on a motion vector of the current block. The original data and the reference data respectively serve as the current sample and the reference sample for generating raw scale and offset parameters 615 for LIC mode. Using original data to generate LIC scale and offset parameters is described in Section I above.

A quantizer 620 quantizes the raw scale and offset parameters 615 into quantized scale and offset parameters 625 and assigns corresponding LIC parameter indices 628. The LIC parameter indices 628 are used to select the quantized values from one or more sets or tables of permissible values for the scale and offset parameters. The LIC parameter indices 628 are provided to the entropy encoder 590 to be encoded as syntax elements in the bitstream 595 (e.g., lic_y_scale_idx, lic_y_offset_idx, lic_cr_scale_idx, lic_cb_offset_idx, etc.) Quantization of LIC parameters is described in Section II above.

If the current block is encoded using LIC mode, then the values of the quantized scale and offset parameters 625 may be stored in a LIC history-based table 650 for future use. The LIC history-based table 650 has multiple entries, each entry stores scale and offset values that were used to encode a previous LIC coded block. In some embodiments, if the current block is to be encoded by LIC mode, the video encoder 500 may retrieve an entry from the history-based table 650 to obtain the scale and offset parameter values. A history-based table index 655 for selecting an entry in the history-based table (e.g., lic_y_hb_idx, lic_cb_hb_idx, lic_cr_hb_idx) is provided to the entropy encoder 590 to be included in the bitstream 595. Operations of the history-based table is described in Section IV above.

The quantized LIC scale and offset parameters 625 are used by the LIC linear model 610 to compute a LIC prediction block 660. The encoder 500 applies the LIC models 610 to the reconstructed pixel data 650 to generate the LIC prediction block 660. The reconstructed picture buffer 550 provides the reconstructed pixel data 650. The inter-prediction module 540 may use the generated LIC prediction block 660 as the predicted pixel data 513 when LIC mode is enabled for the current block.

The video encoder 500 may apply three separate sets of LIC scale and offset parameters for the three components Y/Cr/Cb. The entropy encoder 590 may signal the three sets of quantized scale and offset parameters as syntax elements in the bitstream. The entropy encoder 590 may also signal the LIC parameters as delta scale and/or delta offset in addition to the history-based table index. Section III above describes the syntax for signaling the three sets of quantized scale and offset parameters in different embodiments. For example, the entropy encoder 590 may encode two indices, one for scale, another for offset; the entropy encoder 590 may encode two or three indices, one for Y and the other one or two for Cb and Cr. The indices may be used to select values from tables or sets of permissible values. In some embodiments, the indices may represent only absolute value of the offset, while the sign is coded separately. The tables or sets of permissible values may have different values and range of values for different component (Y/Cr/Cb) or different parameters (scale or offset). The entropy encoder 590 may employ a combined coding of Y/Cb/Cr of scale/offset for all or part of Y/Cb/Cr components. The entropy encoder 590 may send adjustable scale and/or offset value in PPS or PH or SH. The entropy encoder 590 may also encode the LIC parameter values using the delta between the indices of the different color components or the delta between the scale and offset parameters.

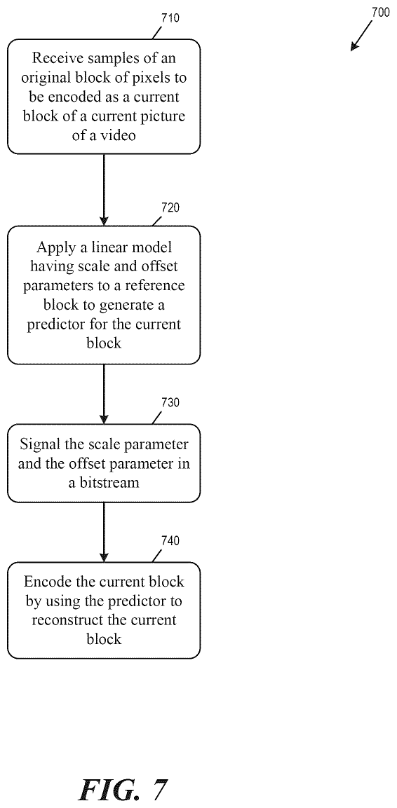

FIG. 7 conceptually illustrates a process 700 for using LIC mode to encode a block of pixels. In some embodiments, one or more processing units (e.g., a processor) of a computing device implementing the encoder 500 performs the process 700 by executing instructions stored in a computer readable medium. In some embodiments, an electronic apparatus implementing the encoder 500 performs the process 700.

The encoder receives (at block 710) samples of an original block of pixels to be encoded as a current block of a current picture of a video.

The encoder applies (at block 720) a linear model to a reference block to generate a prediction block for the current block. The linear model has a scale parameter and an offset parameter. In some embodiments, the samples of the original block and the samples from a reconstructed reference frame are used to derive the scale parameter and the offset parameter. The samples of the reference frame used to derive the scale and offset parameters are referenced by or identified by or based on a motion vector of the current block. In some embodiments, the samples of the original block that are used to derive the scale and offset parameters are those to be encoded as the current block. In other words, the derivation of the linear model uses original pixels that are within the border of the current block instead of the boundary templates that are outside of the border (which are not encoded as part of the current block.)

In some embodiments, the current block is to be encoded as multiple sub-blocks, with each sub-block having its own motion vector referencing pixels in reference frames. The encoder uses the samples of the original block and the samples referenced by the motion vectors of the multiple sub-blocks to derive the scale parameter and the offset parameter of the LIC linear model. The encoder signals (at block 730) the scale parameter and the offset parameter in the bitstream. In some embodiments, the values of the scale and offset parameters are selected from pre-defined sets of permissible values. Each set of permissible values has a finite range and is created by sub-sampling a consecutive sequence of numbers uniformly or non-uniformly. In some embodiments, an index is used to select a value from a predefined set of permissible values. The predefined set of permissible values may be ordered with respect to the index according to probabilities of the permissible values in the set (e.g., a lowest index value corresponds to a highest probability permissible value for the scale parameter.)

In some embodiments, the encoder signals an index for selecting an entry from one or more entries of a history-based table. Each entry of the history-based table includes a scale parameter value and an offset parameter value that are used to encode a previous block. The encoder may update the history-based table with a new entry that includes scale and offset parameter values that are used by the linear model to generate the prediction block.

In some embodiments, separate scale and offset parameters are derived and signaled for luma and chroma components. The signaled luma and chroma scale and offset parameters may be coded by one or more scale parameter indices and/or luma parameter indices that select values for the luma and chroma scale and offset parameters, which are in turn used by the encoder to generate prediction blocks for the luma and chroma components. In some embodiments, an offset parameter index that codes a signaled offset parameter specifies the absolute value but not the sign of the signaled offset parameter.

The encoder encodes (at block 740) the current block by using the prediction block to reconstruct the current block.

### VI. Example Video Decoder

In some embodiments, an encoder may signal (or generate) one or more syntax element in a bitstream, such that a decoder may parse said one or more syntax element from the bitstream.

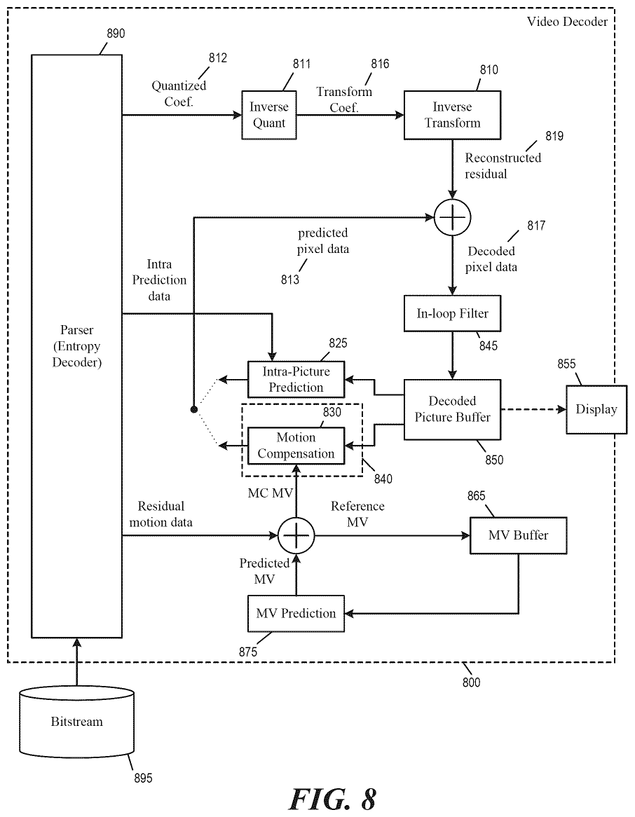

FIG. 8 illustrates an example video decoder 800 that may implement LIC mode. As illustrated, the video decoder 800 is an image-decoding or video-decoding circuit that receives a bitstream 895 and decodes the content of the bitstream into pixel data of video frames for display. The video decoder 800 has several components or modules for decoding the bitstream 895, including some components selected from an inverse quantization module 811, an inverse transform module 810, an intra-prediction module 825, a motion compensation module 830, an in-loop filter 845, a decoded picture buffer 850, a MV buffer 865, a MV prediction module 875, and a parser 890. The motion compensation module 830 is part of an inter-prediction module 840.

In some embodiments, the modules 810-890 are modules of software instructions being executed by one or more processing units (e.g., a processor) of a computing device. In some embodiments, the modules 810-890 are modules of hardware circuits implemented by one or more ICs of an electronic apparatus. Though the modules 810-890 are illustrated as being separate modules, some of the modules can be combined into a single module.

The parser 890 (or entropy decoder) receives the bitstream 895 and performs initial parsing according to the syntax defined by a video-coding or image-coding standard. The parsed syntax element includes various header elements, flags, as well as quantized data (or quantized coefficients) 812. The parser 890 parses out the various syntax elements by using entropy-coding techniques such as context-adaptive binary arithmetic coding (CABAC) or Huffman encoding.

The inverse quantization module 811 de-quantizes the quantized data (or quantized coefficients) 812 to obtain transform coefficients, and the inverse transform module 810 performs inverse transform on the transform coefficients 816 to produce reconstructed residual signal 819. The reconstructed residual signal 819 is added with predicted pixel data 813 from the intra-prediction module 825 or the motion compensation module 830 to produce decoded pixel data 817. The decoded pixels data are filtered by the in-loop filter 845 and stored in the decoded picture buffer 850. In some embodiments, the decoded picture buffer 850 is a storage external to the video decoder 800. In some embodiments, the decoded picture buffer 850 is a storage internal to the video decoder 800.

The intra-prediction module 825 receives intra-prediction data from bitstream 895 and according to which, produces the predicted pixel data 813 from the decoded pixel data 817 stored in the decoded picture buffer 850. In some embodiments, the decoded pixel data 817 is also stored in a line buffer (not illustrated) for intra-picture prediction and spatial MV prediction.

In some embodiments, the content of the decoded picture buffer 850 is used for display. A display device 855 either retrieves the content of the decoded picture buffer 850 for display directly, or retrieves the content of the decoded picture buffer to a display buffer. In some embodiments, the display device receives pixel values from the decoded picture buffer 850 through a pixel transport.

The motion compensation module 830 produces predicted pixel data 813 from the decoded pixel data 817 stored in the decoded picture buffer 850 according to motion compensation MVs (MC MVs). These motion compensation MVs are decoded by adding the residual motion data received from the bitstream 895 with predicted MVs received from the MV prediction module 875.

The MV prediction module 875 generates the predicted MVs based on reference MVs that were generated for decoding previous video frames, e.g., the motion compensation MVs that were used to perform motion compensation. The MV prediction module 875 retrieves the reference MVs of previous video frames from the MV buffer 865. The video decoder 800 stores the motion compensation MVs generated for decoding the current video frame in the MV buffer 865 as reference MVs for producing predicted MVs.

The in-loop filter 845 performs filtering or smoothing operations on the decoded pixel data 817 to reduce the artifacts of coding, particularly at boundaries of pixel blocks. In some embodiments, the filtering operation performed includes sample adaptive offset (SAO). In some embodiment, the filtering operations include adaptive loop filter (ALF).

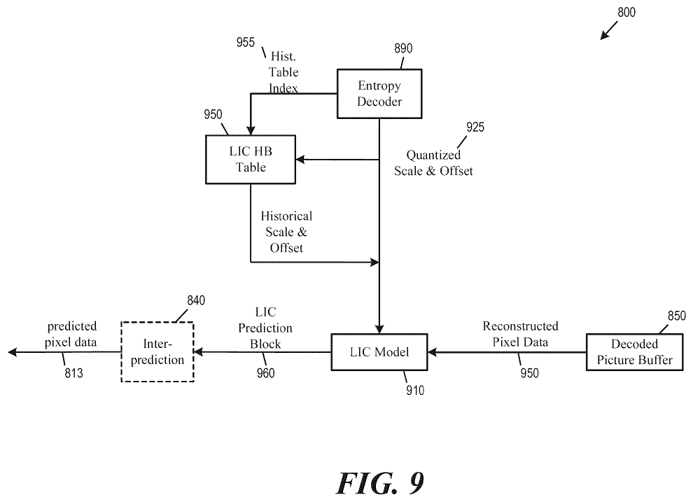

FIG. 9 illustrates portions of the video decoder 800 that implement LIC mode. The entropy decoder 890 may receive LIC parameter indices based on syntax elements in the bitstream 895 (e.g., lic_y_scale_idx, lic_y_offset_idx, lic_cr_scale_idx, lic_cb_offset_idx, etc.). The LIC parameter indices are used to select quantized values from one or more sets or tables of permissible values for LIC scale and offset parameters. The entropy decoder 800 provides the selected quantized value as quantized scale and offset parameters 925. Quantization of LIC parameters is described in Section II above.

The quantized LIC scale and offset parameters 925 are used by a LIC linear model 910 to compute a LIC prediction block 960. The decoder 800 applies the LIC models 910 to reconstructed pixel data 950 to generate the LIC prediction block 960. The decoded picture buffer 850 provides the reconstructed pixel data 950. The inter-prediction module 840 may use the generated LIC prediction block 960 as the predicted pixel data 813 when LIC mode is enabled for the current block.

If the current block is encoded using LIC mode, then the values of the quantized scale and offset parameters 925 may be stored in a LIC history-based table 950 for future use. The LIC history-based table 950 has multiple entries, each entry stores scale and offset values that were used to encode a previous LIC coded block. In some embodiments, if the current block is to be encoded by LIC mode, the video decoder 800 may retrieve an entry from the history-based table 950 to obtain the scale and offset parameter values. A history-based table index 955 (e.g., lic_y_hb_idx, lic_ch_hb_idx, lic_cr_hb_idx) for selecting an entry in the history-based table is parsed from the bitstream 895 by the entropy decoder 890. Operations of the history-based table is described in Section IV above. The video decoder 800 may apply three separate sets of LIC scale and offset parameters for the three components Y/Cr/Cb. The entropy decoder 890 may receive the three sets of quantized scale and offset parameters based on syntax elements in the bitstream 895. The entropy decoder 890 may also receive the LIC parameters as delta scale and/or delta offset in addition to the history-based table index. The values stored in the history-based table can be added with the delta scale/offset values to reconstruct the LIC scale and offset parameter values. Section III above describes the syntax for signaling the three sets of quantized scale and offset parameters in different embodiments. For example, the entropy decoder 890 may receive two indices, one for scale, another for offset; the entropy decoder 890 may receive two or three indices, one for Y and the other one or two for Cb and Cr. The indices may be used to select values from tables or sets of permissible values that are arranged based on probabilities. In some embodiments, the indices may represent only absolute value of the offset, while the sign is coded separately. The tables or sets of permissible values may have different values and range of values for different component (Y/Cr/Cb) or different parameters (scale or offset). The entropy decoder 890 may handle a combined coding of Y/Cb/Cr of scale/offset for all or part of Y/Cb/Cr components. The entropy decoder 890 may receive adjustable scale and/or offset value in PPS or PH or SH. The entropy decoder 890 may also receive the LIC parameter values that are coded using the delta between the indices of the different color components or the delta between the scale and offset parameters.

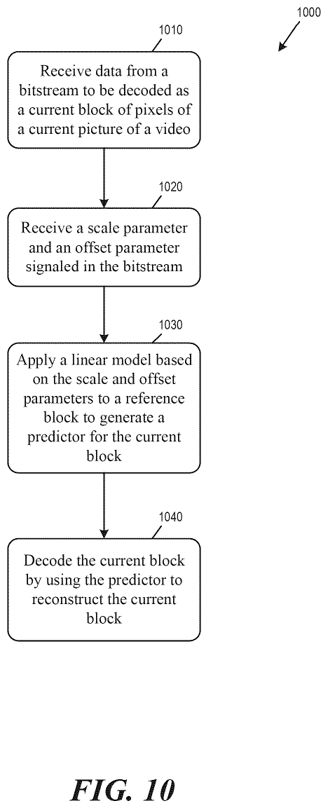

FIG. 10 conceptually illustrates a process 1000 for using LIC mode to decode a block of pixels. In some embodiments, one or more processing units (e.g., a processor) of a computing device implementing the decoder 800 performs the process 1000 by executing instructions stored in a computer readable medium. In some embodiments, an electronic apparatus implementing the decoder 800 performs the process 1000.

The decoder receives (at block 1010) data from a bitstream to be decoded as a current block of pixels in a current picture. The decoder receives (at block 1020) a scale parameter and an offset parameter signaled in the bitstream. In some embodiments, the values of the scale and offset parameters are selected from pre-defined sets of permissible values. Each set of permissible values has a finite range and is created by sub-sampling a consecutive sequence of numbers uniformly or non-uniformly. In some embodiments, an index is used to select a value from a predefined set of permissible values. The predefined set of permissible values may be ordered with respect to the index according to probabilities of the permissible values in the set (e.g., a lowest index value corresponds to a highest probability permissible value for the scale parameter.)

In some embodiments, the decoder receives an index for selecting an entry from one or more entries of a history-based table. Each entry of the history-based table includes a scale parameter value and an offset parameter value that are used to decode a previous block. The decoder may update the history-based table with a new entry that includes scale and offset parameter values that are used by the linear model to generate the prediction block.

In some embodiments, separate scale and offset parameters are derived and signaled for luma and chroma components. The signaled luma and chroma scale and offset parameters may be coded by one or more scale parameter indices and/or luma LIC parameter indices that select values for the luma and chroma scale and offset parameters, which are in turn used by the decoder to generate prediction blocks for the luma and chroma components. In some embodiments, an offset parameter index that codes a signaled offset parameter specifies the absolute value but not the sign of the signaled offset parameter.

The decoder applies (at block 1030) a linear model based on the scale and offset parameters to a reference block to generate a prediction block for the current block. The decoder decodes (at block 1040) the current block by using the prediction block to reconstruct the current block. The decoder may provide the reconstructed current block for display as part of the reconstructed current picture.

### VII. Example Electronic System

Many of the above-described features and applications are implemented as software processes that are specified as a set of instructions recorded on a computer readable storage medium (also referred to as computer readable medium). When these instructions are executed by one or more computational or processing unit(s) (e.g., one or more processors, cores of processors, or other processing units), they cause the processing unit(s) to perform the actions indicated in the instructions. Examples of computer readable media include, but are not limited to, CD-ROMs, flash drives, random-access memory (RAM) chips, hard drives, erasable programmable read only memories (EPROMs), electrically erasable programmable read-only memories (EEPROMs), etc. The computer readable media does not include carrier waves and electronic signals passing wirelessly or over wired connections.

In this specification, the term “software” is meant to include firmware residing in read-only memory or applications stored in magnetic storage which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the present disclosure. In some embodiments, the software programs, when installed to operate on one or more electronic systems, define one or more specific machine implementations that execute and perform the operations of the software programs.

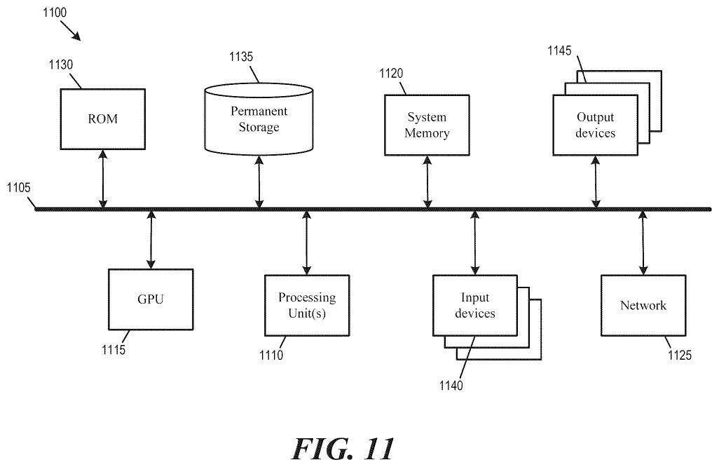

FIG. 11 conceptually illustrates an electronic system 1100 with which some embodiments of the present disclosure are implemented. The electronic system 1100 may be a computer (e.g., a desktop computer, personal computer, tablet computer, etc.), phone, PDA, or any other sort of electronic device. Such an electronic system includes various types of computer readable media and interfaces for various other types of computer readable media. Electronic system 1100 includes a bus 1105, processing unit(s) 1110, a graphics-processing unit (GPU) 1115, a system memory 1120, a network 1125, a read-only memory 1130, a permanent storage device 1135, input devices 1140, and output devices 1145.

The bus 1105 collectively represents all system, peripheral, and chipset buses that communicatively connect the numerous internal devices of the electronic system 1100. For instance, the bus 1105 communicatively connects the processing unit(s) 1110 with the GPU 1115, the read-only memory 1130, the system memory 1120, and the permanent storage device 1135.

From these various memory units, the processing unit(s) 1110 retrieves instructions to execute and data to process in order to execute the processes of the present disclosure. The processing unit(s) may be a single processor or a multi-core processor in different embodiments. Some instructions are passed to and executed by the GPU 1115. The GPU 1115 can offload various computations or complement the image processing provided by the processing unit(s) 1110.

The read-only-memory (ROM) 1130 stores static data and instructions that are used by the processing unit(s) 1110 and other modules of the electronic system. The permanent storage device 1135, on the other hand, is a read-and-write memory device. This device is a non-volatile memory unit that stores instructions and data even when the electronic system 1100 is off. Some embodiments of the present disclosure use a mass-storage device (such as a magnetic or optical disk and its corresponding disk drive) as the permanent storage device 1135.

Other embodiments use a removable storage device (such as a floppy disk, flash memory device, etc., and its corresponding disk drive) as the permanent storage device. Like the permanent storage device 1135, the system memory 1120 is a read-and-write memory device. However, unlike storage device 1135, the system memory 1120 is a volatile read-and-write memory, such a random access memory. The system memory 1120 stores some of the instructions and data that the processor uses at runtime. In some embodiments, processes in accordance with the present disclosure are stored in the system memory 1120, the permanent storage device 1135, and/or the read-only memory 1130. For example, the various memory units include instructions for processing multimedia clips in accordance with some embodiments. From these various memory units, the processing unit(s) 1110 retrieves instructions to execute and data to process in order to execute the processes of some embodiments.

The bus 1105 also connects to the input and output devices 1140 and 1145. The input devices 1140 enable the user to communicate information and select commands to the electronic system. The input devices 1140 include alphanumeric keyboards and pointing devices (also called “cursor control devices”), cameras (e.g., webcams), microphones or similar devices for receiving voice commands, etc. The output devices 1145 display images generated by the electronic system or otherwise output data. The output devices 1145 include printers and display devices, such as cathode ray tubes (CRT) or liquid crystal displays (LCD), as well as speakers or similar audio output devices. Some embodiments include devices such as a touchscreen that function as both input and output devices.

Finally, as shown in FIG. 11, bus 1105 also couples electronic system 1100 to a network 1125 through a network adapter (not shown). In this manner, the computer can be a part of a network of computers (such as a local area network (“LAN”), a wide area network (“WAN”), or an Intranet, or a network of networks, such as the Internet. Any or all components of electronic system 1100 may be used in conjunction with the present disclosure.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, many of the above-described features and applications are performed by one or more integrated circuits, such as application specific integrated circuits (ASICs) or field programmable gate arrays (FPGAs). In some embodiments, such integrated circuits execute instructions that are stored on the circuit itself. In addition, some embodiments execute software stored in programmable logic devices (PLDs), ROM, or RAM devices.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium,” “computer readable media,” and “machine readable medium” are entirely restricted to tangible, physical objects that store information in a form that is readable by a computer. These terms exclude any wireless signals, wired download signals, and any other ephemeral signals.

While the present disclosure has been described with reference to numerous specific details, one of ordinary skill in the art will recognize that the present disclosure can be embodied in other specific forms without departing from the spirit of the present disclosure. In addition, a number of the figures (including FIG. 7 and FIG. 10) conceptually illustrate processes. The specific operations of these processes may not be performed in the exact order shown and described. The specific operations may not be performed in one continuous series of operations, and different specific operations may be performed in different embodiments. Furthermore, the process could be implemented using several sub-processes, or as part of a larger macro process. Thus, one of ordinary skill in the art would understand that the present disclosure is not to be limited by the foregoing illustrative details, but rather is to be defined by the appended claims.

### ADDITIONAL NOTES

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A video decoding method comprising:
receiving data from a bitstream to be decoded as a current block of pixels of a current picture of a video;
receiving a scale parameter and an offset parameter that are signaled in the bitstream;
applying a linear model to a reference block to generate a prediction block for the current block, wherein the linear model comprises the scale parameter and the offset parameter; and
decoding the current block by using the prediction block to reconstruct the current block.

2. A video encoding method comprising:
receiving samples for an original block of pixels to be encoded as a current block of a current picture of a video;
applying a linear model to a reference block to generate a prediction block for the current block, wherein the linear model comprises a scale parameter and an offset parameter;
signaling the scale parameter and the offset parameter in a bitstream; and
encoding the current block by using the prediction block to reconstruct the current block.

3. The video encoding method of claim 2, further comprising using the samples of the original block and samples from a reconstructed reference frame to derive the scale parameter and the offset parameter.

4. The video encoding method of claim 3, wherein the samples of the original block that are used to derive the scale and offset parameters are to be encoded as the current block.

5. The video encoding method of claim 3, wherein the samples of the reference frame used to derive the scale and offset parameters are referenced by a motion vector of the current block.

6. The video encoding method of claim 2, further comprising using (i) the samples of the original block and (ii) samples referenced by a plurality of motion vectors associated with a plurality of sub-blocks of the current block to derive the scale parameter and the offset parameter.

7. The video encoding method of claim 2, wherein values of the scale and offset parameters used by the linear model to generate the prediction block are selected from pre-defined sets of permissible values, wherein each set of permissible values has a finite range and is created by sub-sampling a consecutive sequence of numbers uniformly or non-uniformly.

8. The video encoding method of claim 7, wherein an index is used to select a value from a predefined set of permissible values,

9. The video encoding method of claim 8, wherein the predefined set of permissible values are ordered with respect to the index according to probabilities of the permissible values in the set.

10. The video encoding method of claim 2, wherein the signaled scale and offset parameters are luma scale and offset parameters for generating a prediction block for a luma component, the method further comprising deriving and signaling chroma scale and offset parameters for generating one or more prediction blocks for one or more chroma components.

11. The video encoding method of claim 10, wherein:
the signaled luma and chroma scale parameters are coded by one or more scale parameter indices that select values for the luma and chroma scale parameters,
the signaled luma and chroma offset parameters are coded by one or more offset parameter indices that select values for the luma and chroma offset parameters.

12. The video encoding method of claim 11, wherein an offset parameter index that codes a signaled offset parameter specifies the absolute value and does not specify the sign of the signaled offset parameter.

13. The video encoding method of claim 2, wherein signaling the scale parameter and the offset parameter comprises signaling an index for selecting an entry from one or more entries of a history-based table, each entry of the history-based table comprising historical scale and offset parameter values that are used to encode a previous block.

14. The video encoding method of claim 13, further comprising updating the history-based table with a new entry comprising a scale parameter value and an offset parameter value that are used by the linear model to generate the prediction block.

15. The video encoding method of claim 14, further comprising signaling one or more delta values that are to be added to the historical scale and offset parameter values stored in the selected entry of the history-based table.

16. The video encoding method of claim 15, wherein the signaled one or more delta values comprise separate delta values for different color components.

17. A video coding method comprising:
receiving data to be encoded or decoded as a current block of a current picture of a video;
signaling or receiving a scale parameter and an offset parameter;
applying a linear model to a reference block to generate a prediction block for the current block, wherein the linear model comprises the scale parameter and the offset parameter; and
reconstruct the current block by using the prediction block.

18. An electronic apparatus comprising:
a video decoder or encoder circuit configured to perform operations comprising:
receiving data to be encoded or decoded as a current block of a current picture of a video;
signaling or receiving a scale parameter and an offset parameter;
applying a linear model to a reference block to generate a prediction block for the current block, wherein the linear model comprises the scale parameter and the offset parameter; and
reconstruct the current block by using the prediction block.
